(19) United States
(12) Patent Application Publication
(10) Pub. No.: US 2014/0337188 A1
(43) Pub. Date: Nov. 13, 2014

(54) ELECTRONIC INVOICING AND PAYMENT

(71) Applicant: Invoice Cloud Incorporated, Braintree, MA (US)

(72) Inventors: Robert Bennett, Boston, MA (US); Robert Lapides, Walpole, MA (US); John Morabito, Vienna, VA (US); Kelton Averyt, Rancho Viejo, TX (US)

(21) Appl. No.: 13/890,792

(22) Filed: May 9, 2013

(51) Int. Cl. G06Q 20/10; G06Q 40/00

(52) U.S. Cl. CPC G06Q 20/102; G06Q 40/12
USPC 705/30; 705/40

(57) ABSTRACT

A method includes maintaining match data indicative of a correspondence between a past payment and a past invoice of a biller, the correspondence having previously been inferred from data associated with the past payment and data associated with the past invoice; and inferring a correspondence between a received payment and another invoice of the biller based on (i) data associated with the received payment and data associated with the other invoice and (ii) the match data for the biller.

### CROSS-REFERENCE TO RELATED APPLICATIONS

This application is related to U.S. Patent Pub. No. 2011/0270749, filed Apr. 29, 2011, the entire contents of which are incorporated here by reference.

### BACKGROUND

Before the advent of computers, when an entity, such as a landlord or a municipality, would present a bill to an individual or another entity, this bill was generally in paper form and would be hand delivered or mailed to the payer. In most instances, the payer would directly pay the bill by presenting the biller with cash or a check. Alternatively, if the biller was a merchant, the payer could present a credit card to the merchant. The credit card issuing company would then present a bill to the payer which would generally be paid by a check.

The utilization of computers and emails has changed the method in which payments can be made between the biller and the payer. The biller can establish an automated system between the payer and the payer's banking institution which will automatically deduct the payment from the payer's account. Additionally, computer systems would allow for the payment between the payer and the biller utilizing an electronic check. This payment process can be inefficient, particularly when multiple payments or invoices are due.

### SUMMARY

In general, in an aspect, a method includes maintaining match data indicative of a correspondence between a past payment and a past invoice of a biller, the correspondence having previously been inferred from data associated with the past payment and data associated with the past invoice; and inferring a correspondence between a received payment and another invoice of the biller based on (i) data associated with the received payment and data associated with the other invoice and (ii) the match data for the biller.

Implementations may include one or more of the following features.

Maintaining match data includes maintaining match data for each of a plurality of billers, the match data for each biller indicative of a correspondence between a past payment and an invoice of the biller. The match data for each biller is indicative of a correspondence between a plurality of past payments and a respective plurality of invoices of the biller.

Maintaining match data includes maintaining match data indicative of a correspondence between a plurality of past payments and a respective plurality of invoices of the biller.

The data associated with the received payment include one or more of a name associated with the received payment, an amount of the received payment, and contents of a memo associated with the received payment. The data associated with the other invoice include one or more of a name associated with the other invoice, an amount due on the other invoice, a total amount due on an account associated with the other invoice, an account number associated with the other invoice, and an invoice number associated with the other invoice.

Inferring a correspondence between a received payment and another invoice includes inferring the correspondence based on data associated with the past payment that matches data associated with the received payment, data associated with the past invoice that matches data associated with the other invoice, or both. The data associated with the received payment comprises a name and the data associated with the past invoice comprises a name. The data associated with the received payment comprises a name and the data associated with the past invoice comprises an account number.

Inferring a correspondence between a received payment and another invoice includes rating the other invoice. The rating is indicative of a degree of correspondence between the received payment and the other invoice. Rating the other invoice includes assigning a first rating to the other invoice based on the data associated with the received payment and data associated with the other invoice; and assigning a second rating to the other invoice based on the match data. The second rating is higher than the first rating. The second rating is higher than the first rating when data associated with the past payment matches data associated with the received payment, data associated with the past invoice matches data associated with the other invoice, or both. The match data are indicative of a correspondence between a plurality of past payments and a respective plurality of past invoices. The second rating is based on a number of past payments for which data associated with the past payment matches data associated with the received payment, a number of past invoices for which data associated with the past invoice matches data associated with the other invoice, or both.

The method includes identifying two or more other invoices corresponding to the received payment. The method includes rating each other invoice.

The method includes associating the received payment with the other invoice. The method includes enabling processing of the received payment. The method includes enabling a payment confirmation notification to be sent to a recipient of the other invoice.

The method includes enabling presentation of the data associated with the received payment, data associated with the other invoice, or both, to a user.

The method includes receiving input from a user about the other invoice. The input from the user about the other invoice includes a confirmation of the inferred correspondence between the received payment and the other invoice. The method includes associating the received payment with the other invoice based on the confirmation.

The method includes maintaining match data indicative of a correspondence between the received payment and the other invoice.

The past payment comprises a payment made by a paper check.

The past payment comprises a payment made by an online bank payment process.

In general, in an aspect, a computer readable storage medium stores instructions for causing a computing system to maintain match data indicative of a correspondence between a past payment and a past invoice of a biller, the correspondence having previously been inferred from data associated with the past payment and data associated with the past invoice; and infer a correspondence between a received payment and another invoice of the biller based on (i) data associated with the received payment and data associated with the other invoice and (ii) the match data for the biller.

In general, in an aspect, a method includes enabling a customer, through a user interface of a computing device, to specify a schedule for payment of an invoice, including enabling the customer to specify payment timing information; and facilitating automatic payment of the invoice according to the payment schedule specified by the customer.

Implementations may include one or more of the following features.

The method includes determining a date and amount for each payment in the schedule based on the specified payment timing information. The method includes determining a data and amount for each payment in the schedule based on payment amount information specified by the customer.

The method includes providing a date and an amount for each payment represented by the schedule for display on the user interface.

The method includes enabling the customer to change a date, an amount, or both, for one or more payments represented by the schedule. The method includes determining an adjusted date, an adjusted amount, or both, for each payment represented by the schedule based on the change.

The method includes enabling the customer to cancel a payment represented by the schedule. The method includes determining an adjusted date, an adjusted amount, or both, for each remaining payment represented by the schedule based on the cancellation.

The payment timing information includes one or more of a date for a particular payment, a number of payments, and a frequency of payments. The date for a particular payment includes a date for a first payment in the schedule, a date for a last payment in the schedule, or both.

Enabling a customer to specify a schedule includes enabling the customer to specify payment amount information.

The payment amount information includes an amount to be paid in each payment, a total amount to be paid over all payments, or both.

Enabling a customer to specify a schedule includes enabling the customer to specify a schedule subject to a rule established by an entity issuing the invoice. The rule includes a maximum number of payments, a minimum amount of each payment, or both. The method includes enabling the entity issuing the invoice to specify the rule.

The method includes enabling a first customer to specify a schedule for payment of a first invoice issued by a first entity and enabling a second customer to specify a schedule for payment of a second invoice issued by a second entity independent of the first entity. Enabling two or more customers to each specify a schedule includes enabling each customer to specify a schedule subject to a rule established by the entity issuing the invoice for the customer. The method includes enabling the first entity to specify a rule for the schedule independently of the second entity.

The method includes enabling a schedule notification including the date, the amount, or both, of each payment represented by the schedule to be sent to the customer.

The method includes enabling a scheduled payment notification to be sent to the customer a predetermined amount of time prior to the date of each particular payment represented by the schedule. The predetermined amount of time is three days prior to the date of each payment.

The method includes enabling a payment confirmation notification to be sent to the customer after each payment in the schedule is completed.

In general, in an aspect, a computer readable storage medium stores instructions for causing a computing system to enable a customer, through a user interface of a computing device, to specify a schedule for payment of an invoice, including enabling the customer to specify payment timing information; and facilitate automatic payment of the invoice according to the payment schedule specified by the customer.

In general, in an aspect, a method includes enabling a customer to establish automatic payments through a payment system for one or more invoices related to a property; and based on a change related to a person associated with the property, canceling the automatic payments through the payment system for the one or more invoices related to the property.

Implementations may include one or more of the following features.

The change in a person associated with the property includes a change in ownership of the property. The change of ownership of the property includes that the customer does not own the property. Detecting a change in ownership includes detecting that the property has been bought, sold, or both. The change in ownership includes a name on a title for the property. The change in ownership includes a change in the name on the title for the property. The change in ownership of the property includes a change in a public record associated with the property.

The customer is a first customer, and the change in a person associated with the property includes that a second customer performs an action associated with the property through the payment system.

The customer is a first customer, and the change in a person associated with the property includes that a second customer establishes an account with the payment system, links an established account with the property, or both.

A change in a person associated with the property includes a change in a name associated with the one or more invoices. A change in a name associated with the one or more invoices includes that the name of the customer is not associated with the one or more invoices.

The method includes detecting the change in a person associated with the property. Detecting the change includes automatically detecting the change. Automatically detecting the change includes detecting the change without requesting input from a user.

Canceling the automatic payments includes automatically canceling the automatic payments. Automatically canceling the automatic payments includes canceling the automatic payments without requesting input from the customer, from a user other than the customer, or both.

The method includes requesting confirmation of the cancellation from the customer. Requesting confirmation includes requesting confirmation prior to canceling the automatic payments.

The method includes sending a cancellation notification to the customer.

Advantages may include one or more of the following.

The systems and methods described here allow multiple billers to each have independent control of the appearance and operation of an online invoice and payment customer portal through which its customers can view and pay their invoices. Each biller can independently specify its own business rules related to payment of invoices and communication with customers to suit its own business needs, to satisfy relevant regulations, and to enhance profitability and customer satisfaction. Each biller can create a private labeled version of the customer portal that is branded as though it were presented by the biller. The appearance of a branded portal can help assure the comfort, confidence, and loyalty of the biller's customers, thus increasing customer participation in the online services offered by the portal and saving money and improving efficiency for the biller. Each biller can also independently control the mode, timing, and content of communications, such as email communications, with its customers.

The customer portal offers customers the convenience of online bill paying to entities such as cities, utility companies, and landlords. Each customer can establish payment methods and schedules that suit his needs, provided the payment methods and schedules satisfy any business rules that apply to the customer's invoices.

These and other aspects, features, and implementations, and combinations of them, can be expressed as methods, apparatus, systems, components, software products, business methods, means and steps for performing functions, and in other ways. Other features and advantages will be apparent from the following description and from the claims.

### DESCRIPTION

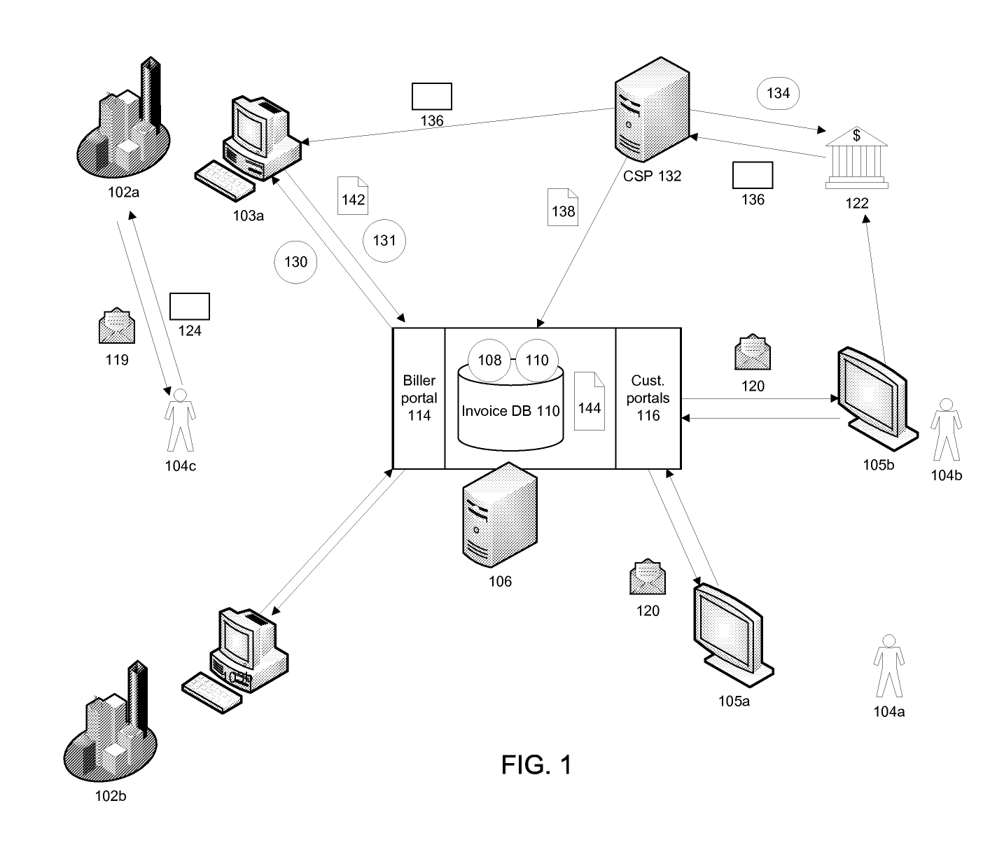

FIG. 1 is a block diagram.

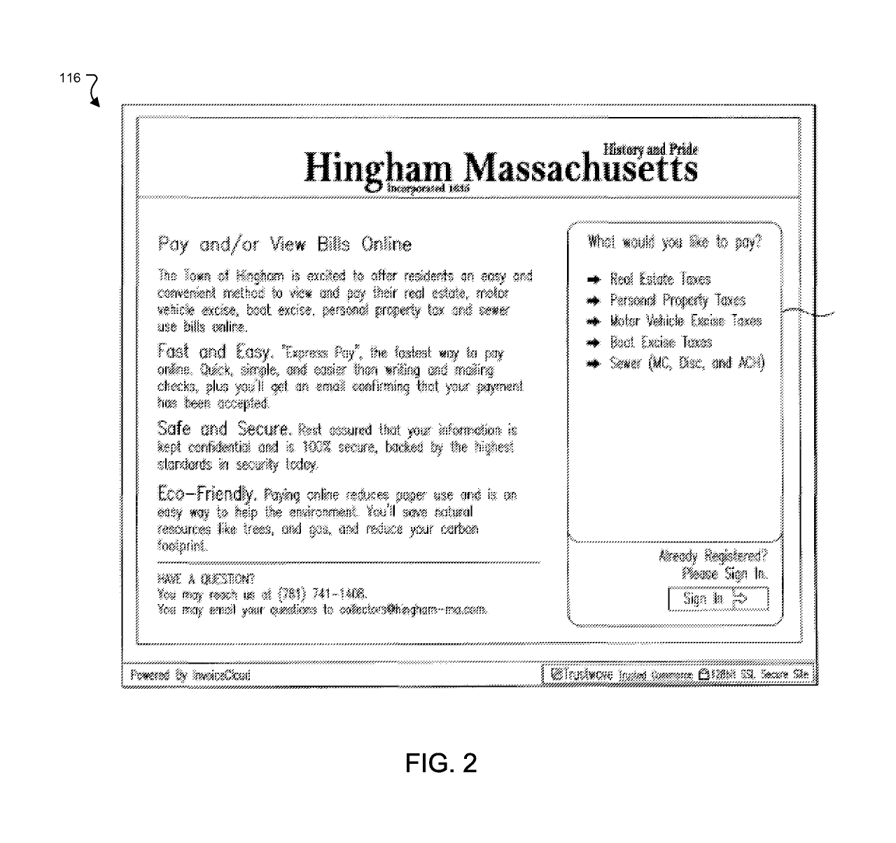

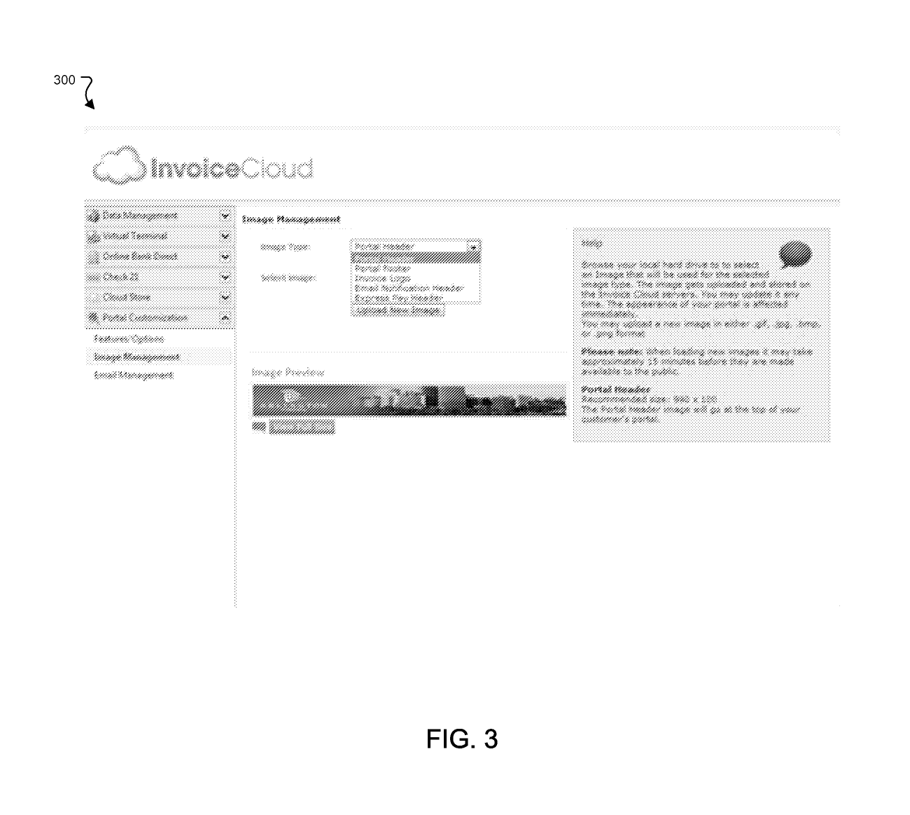

FIGS. 2-3 are screenshots.

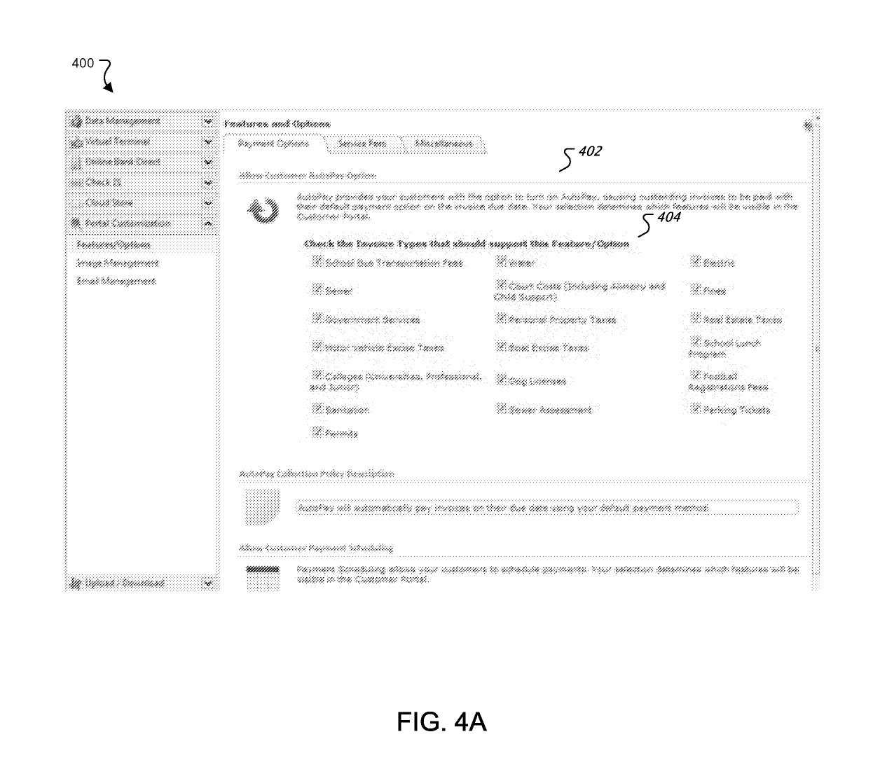

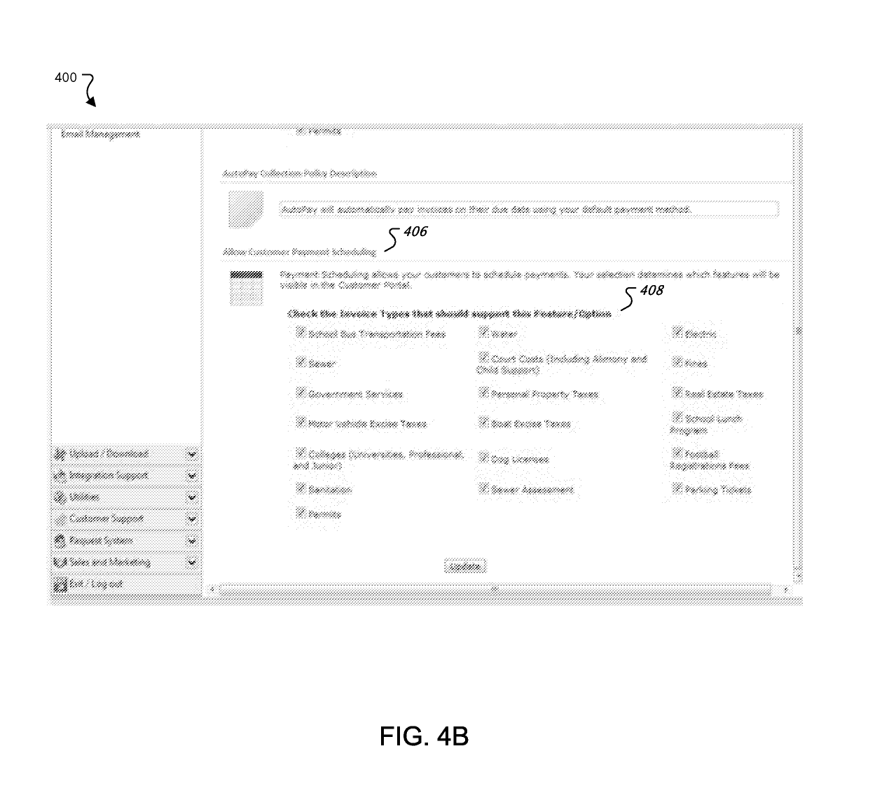

FIGS. 4A and 4B are screenshots.

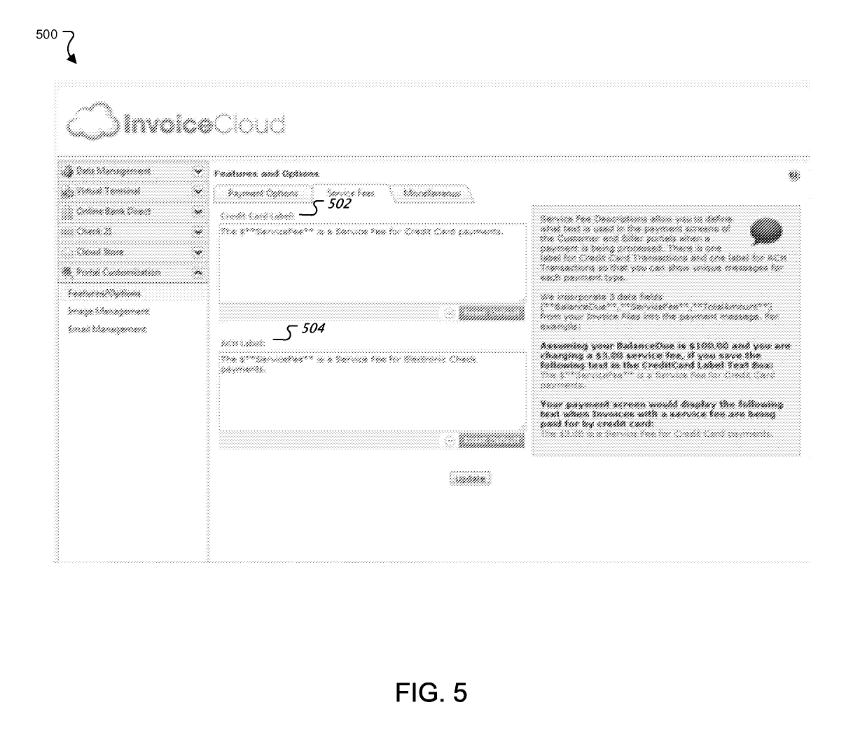

FIG. 5 is a screenshot.

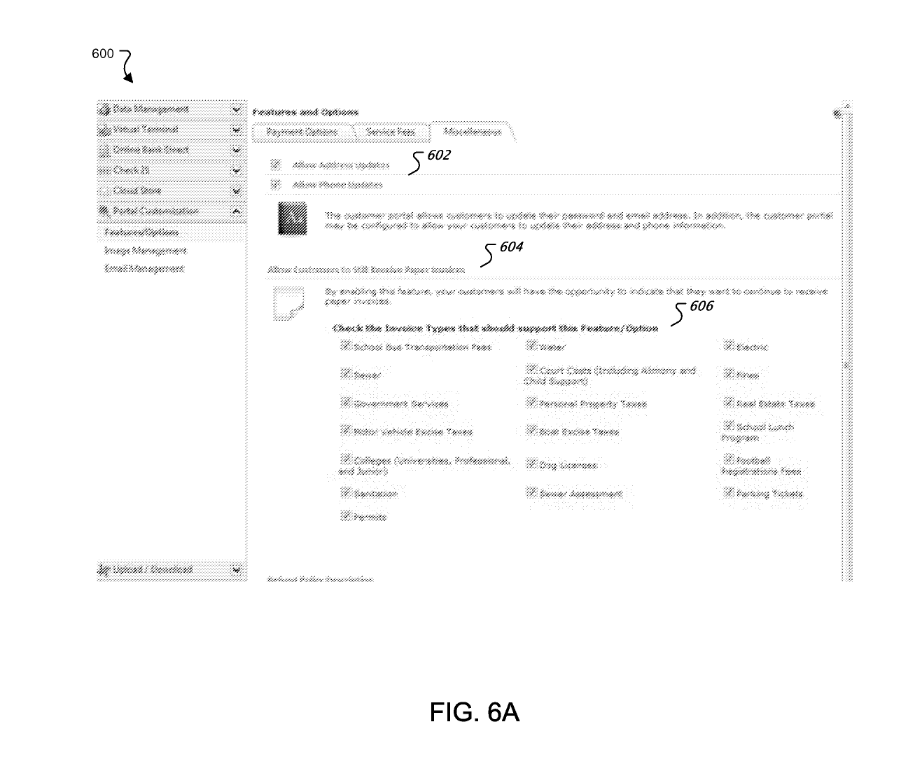

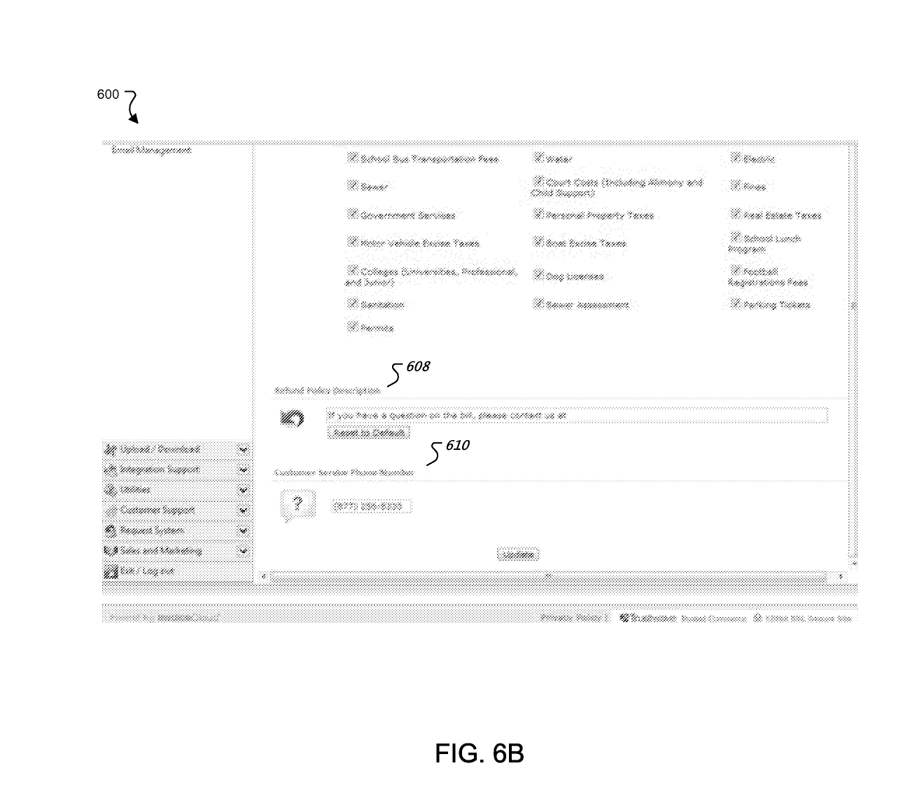

FIGS. 6A and 6B are screenshots.

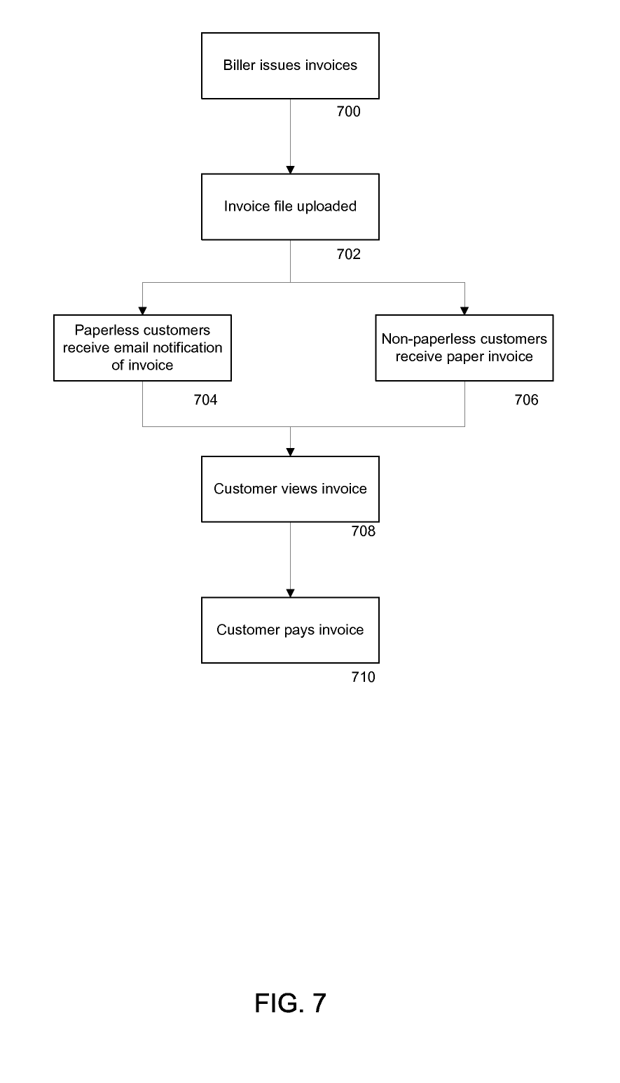

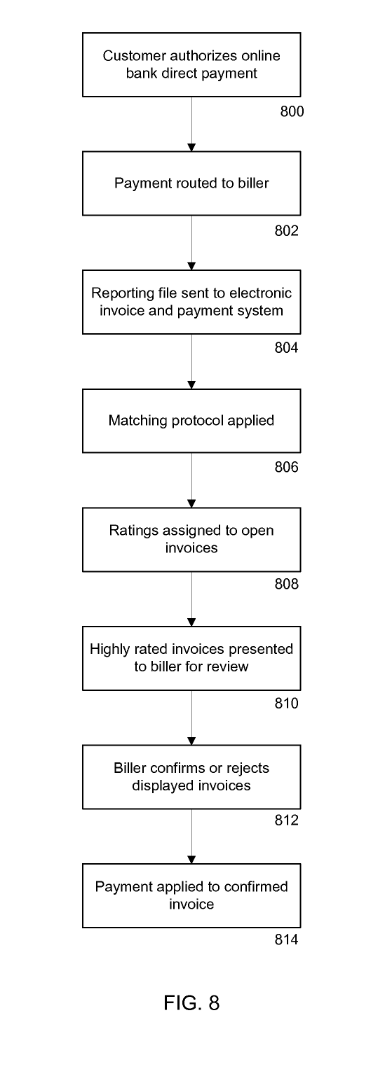

FIGS. 7 and 8 are flowcharts.

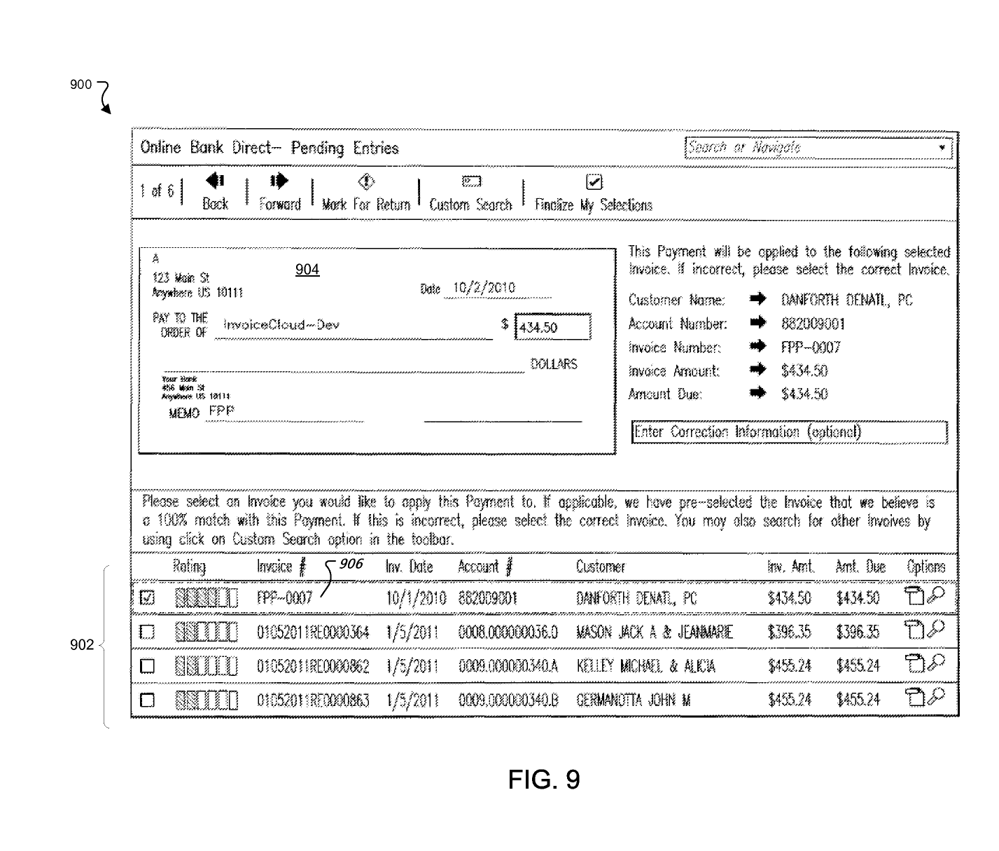

FIG. 9 is a screenshot.

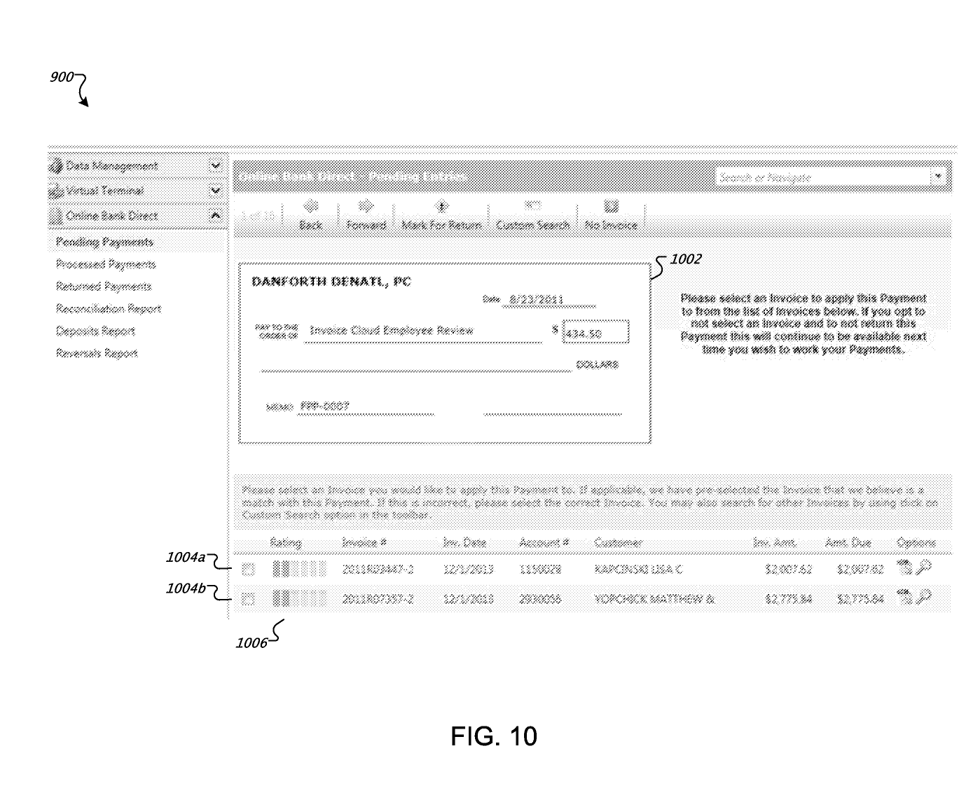

FIGS. 10-13 are screenshots.

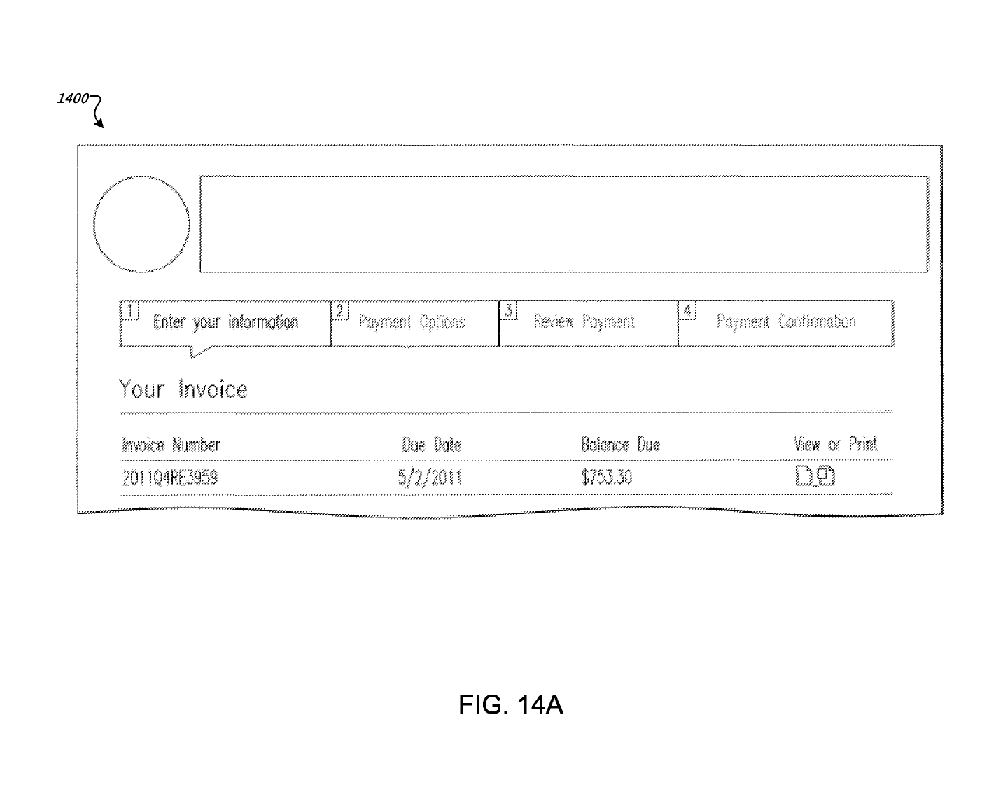

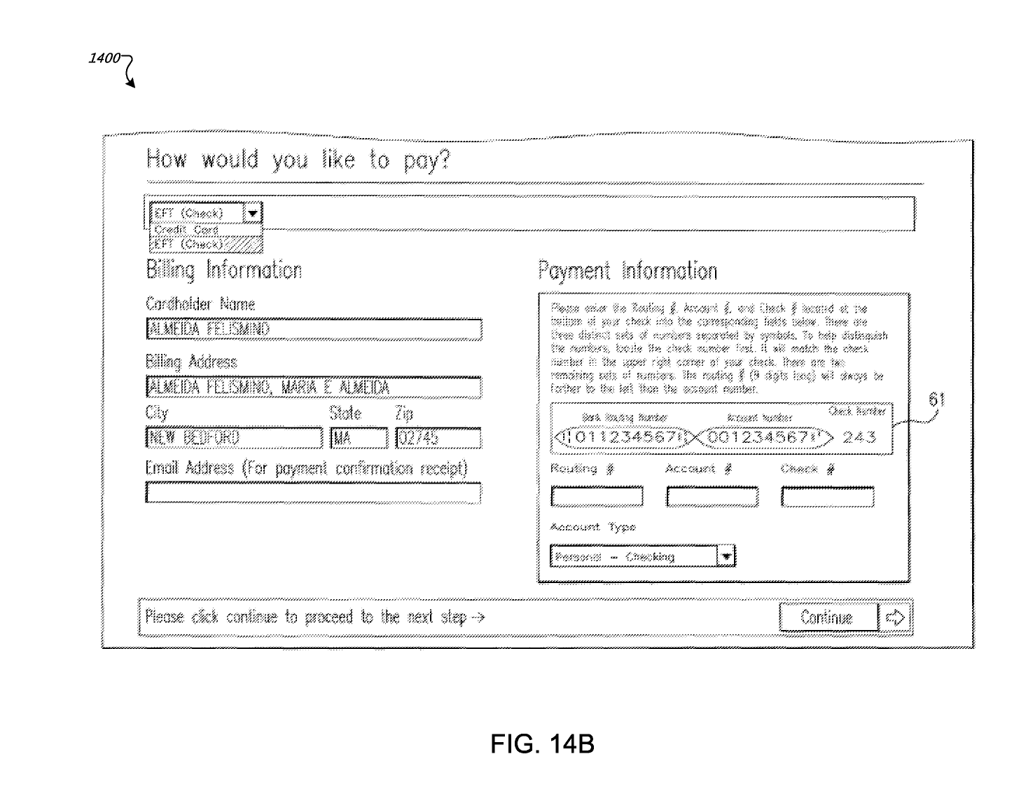

FIGS. 14A and 14B are screenshots.

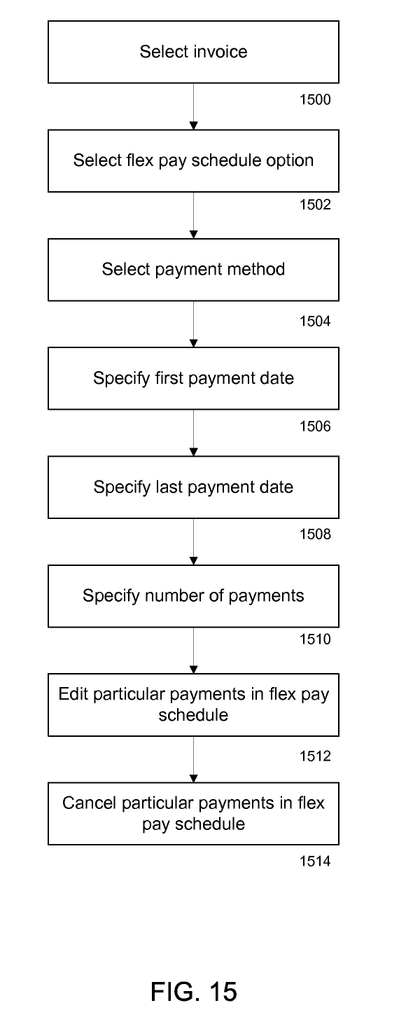

FIG. 15 is a flowchart.

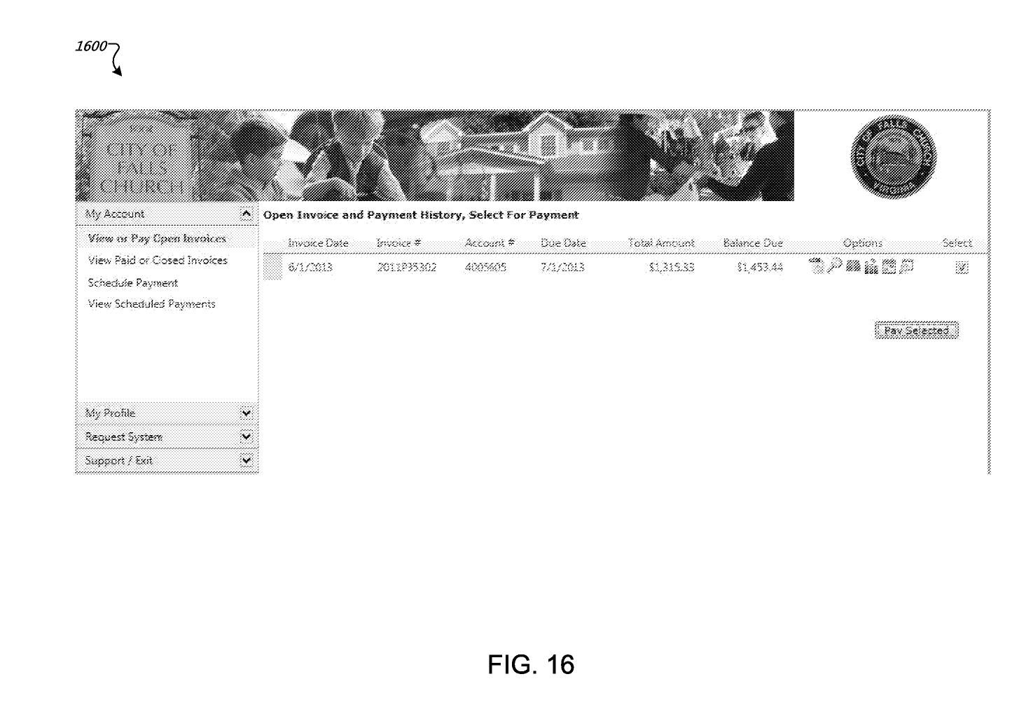

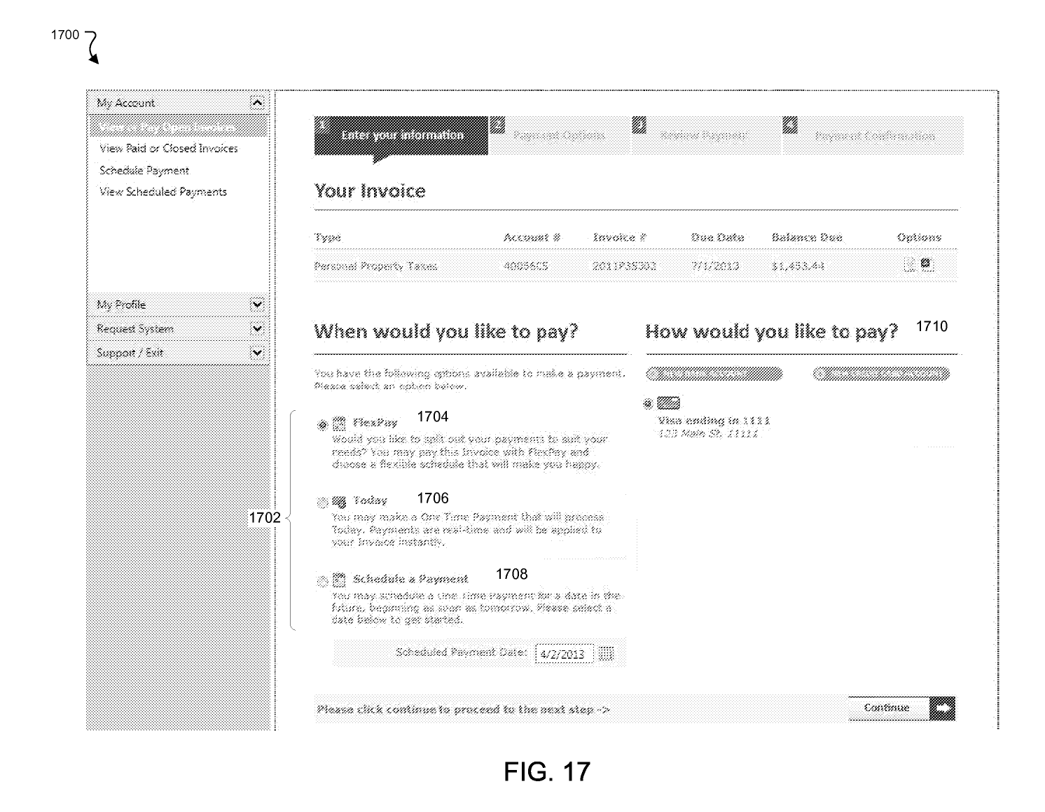

FIGS. 16 and 17 are screenshots.

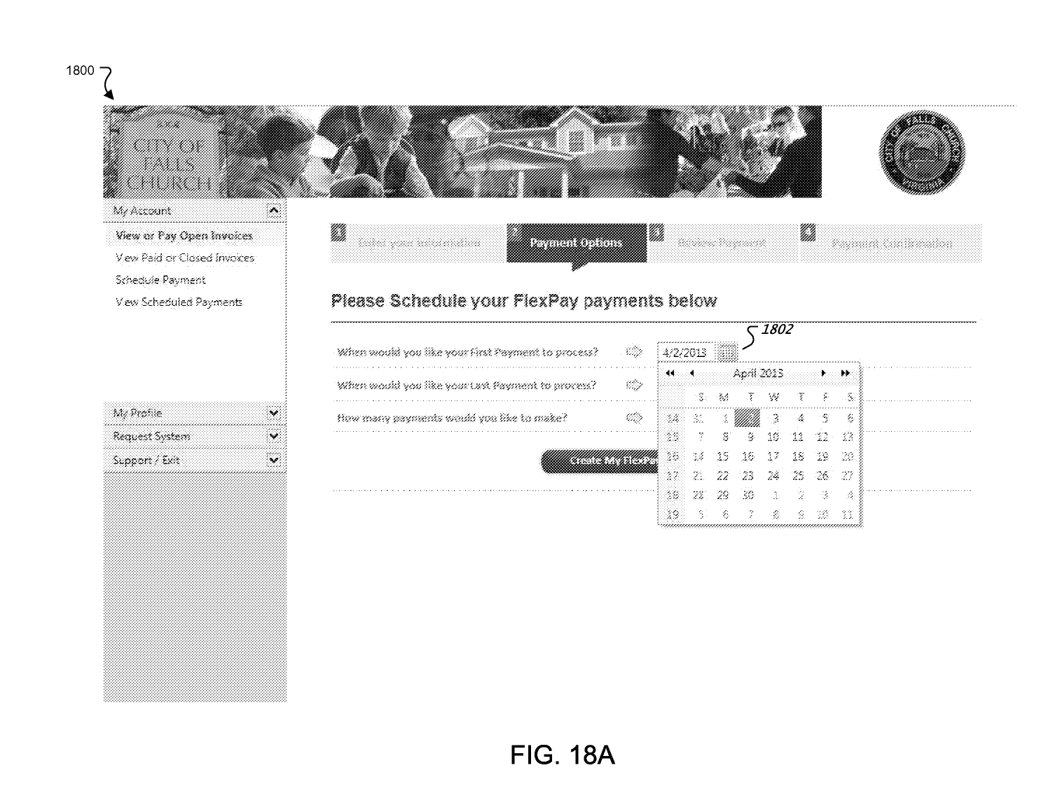

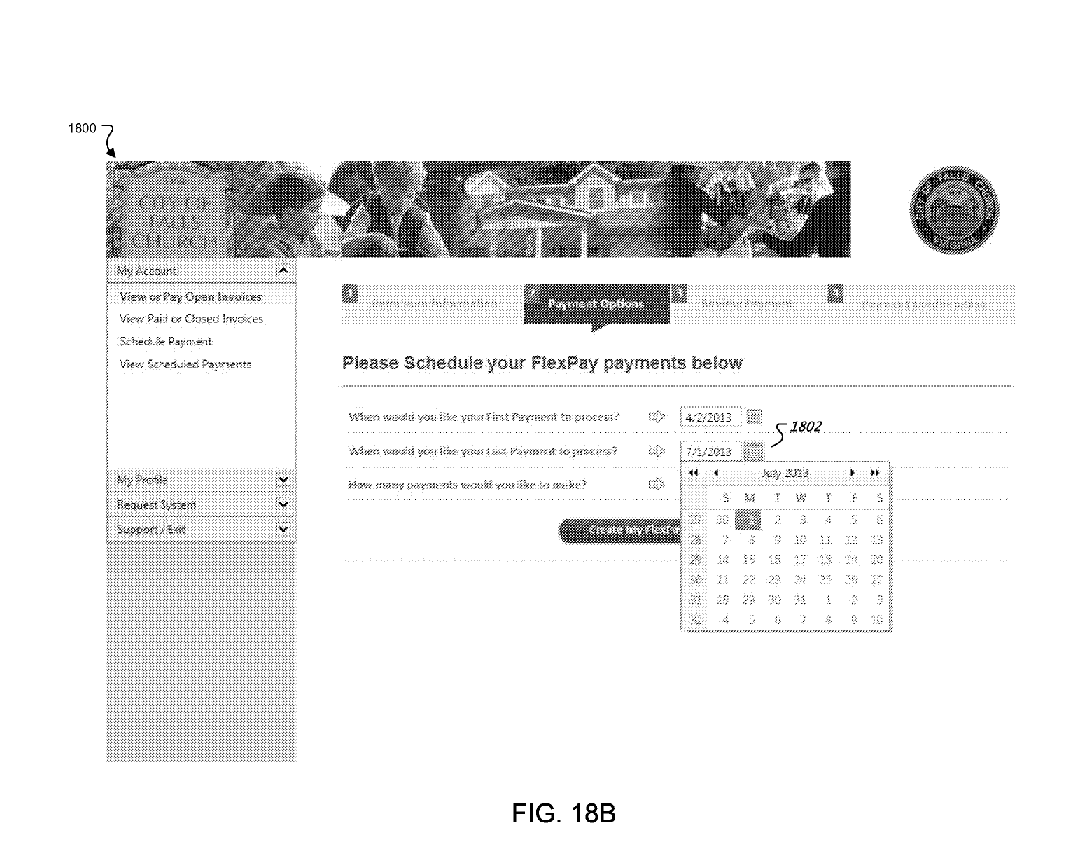

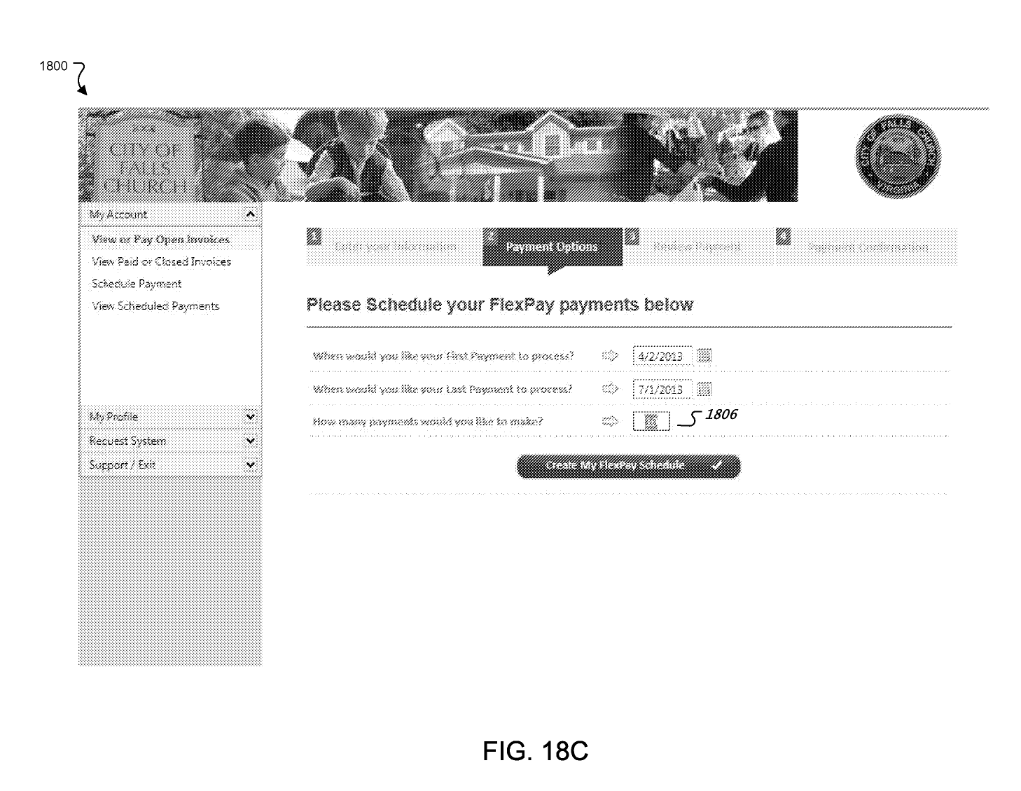

FIGS. 18A-18C are screenshots.

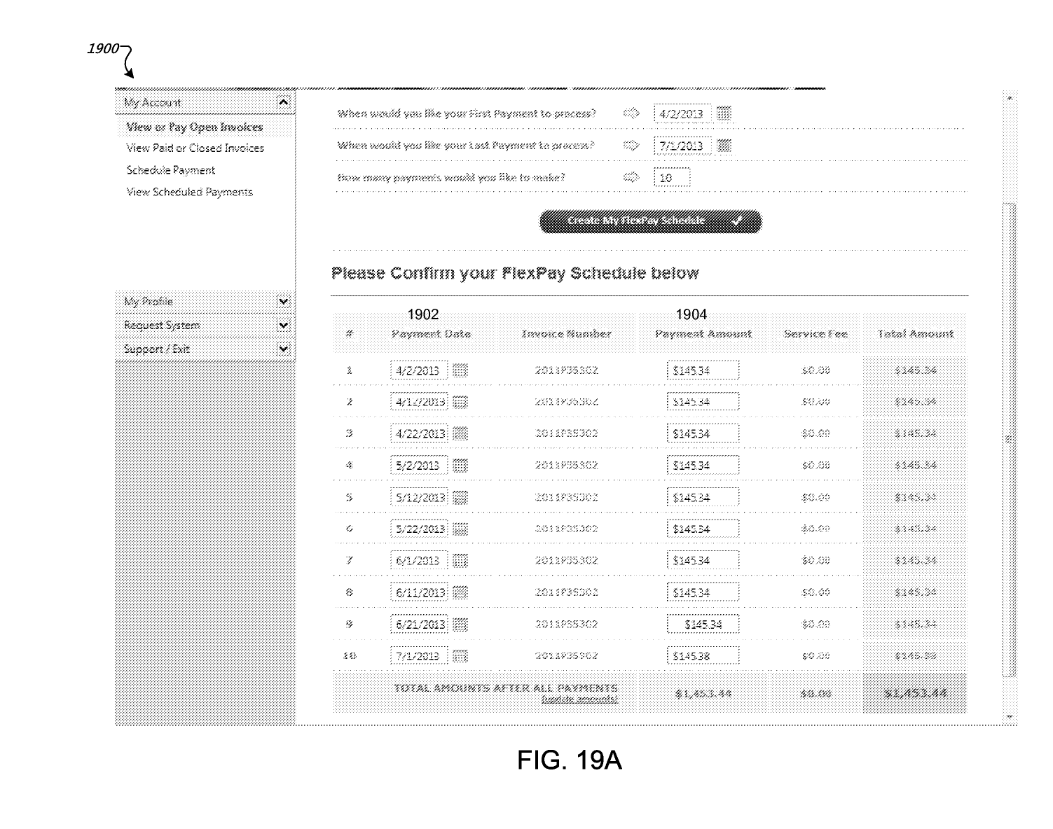

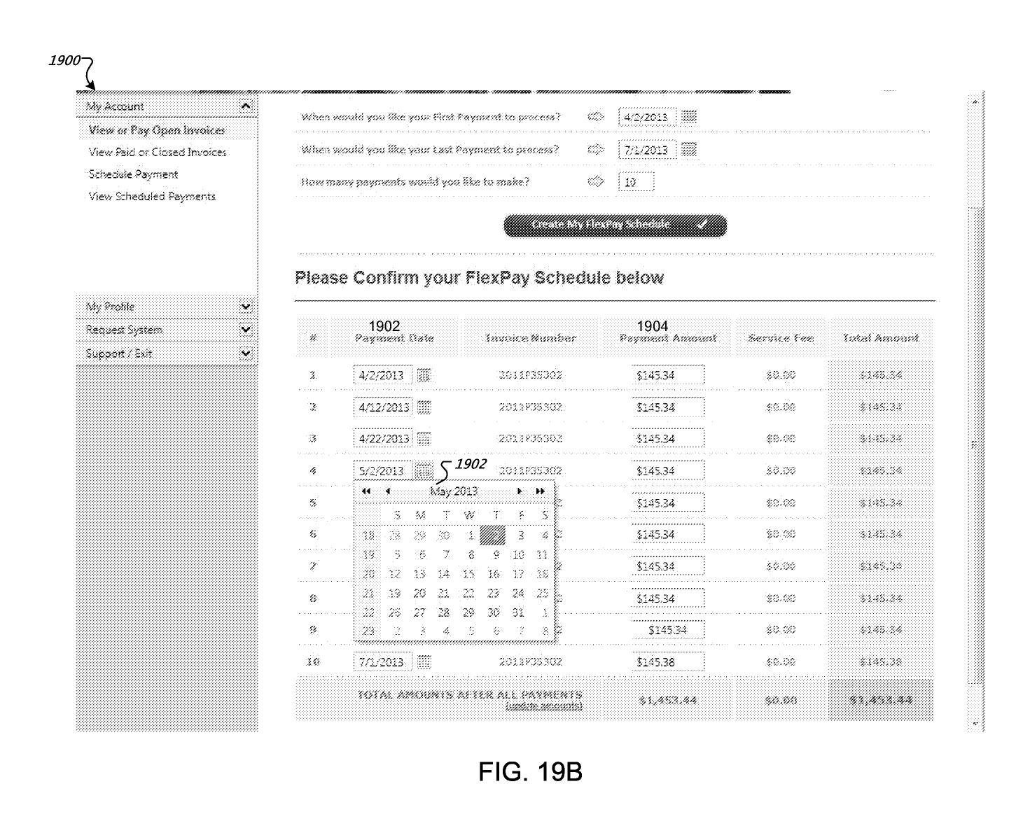

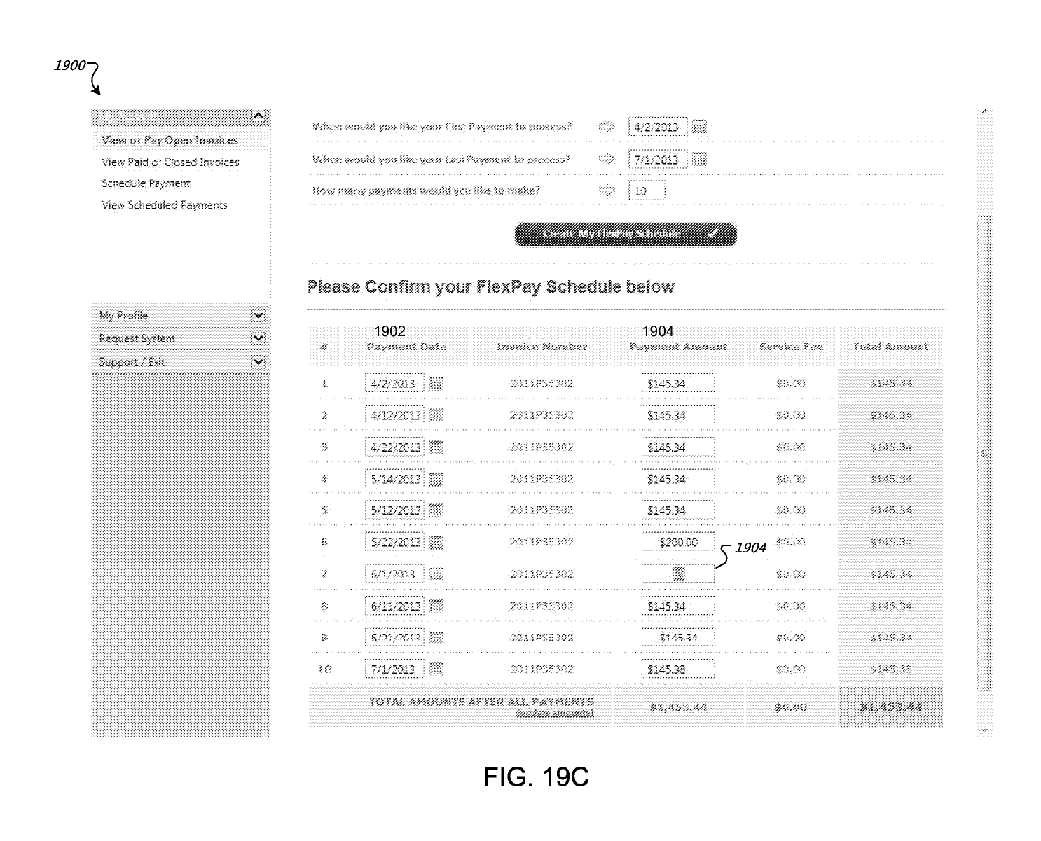

FIGS. 19A-19C are screenshots.

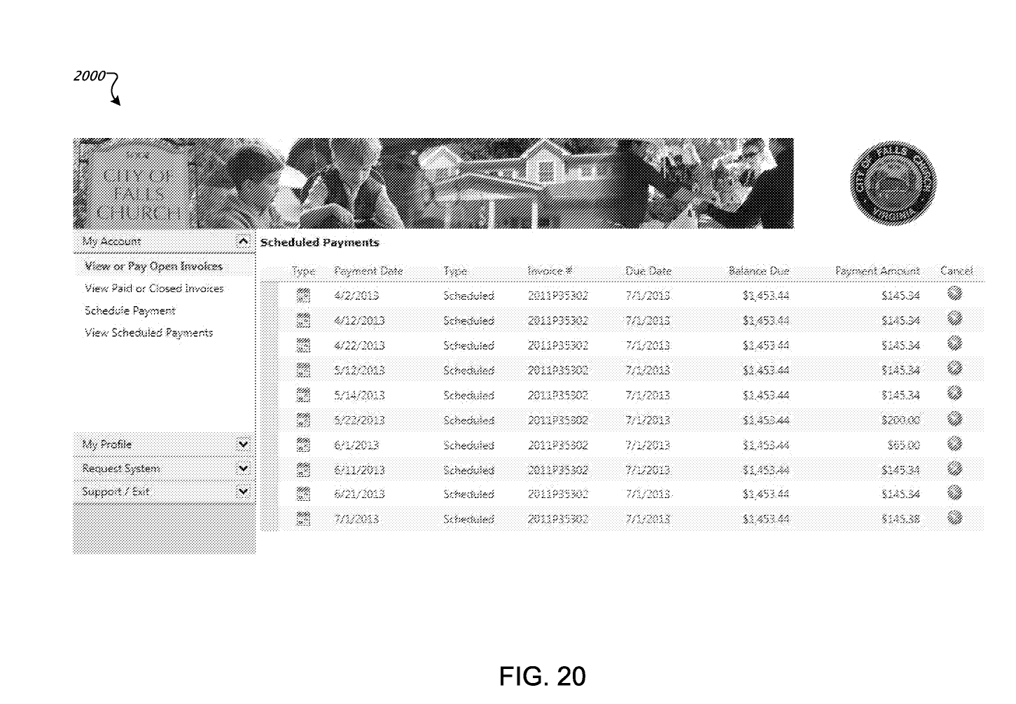

FIG. 20 is a screenshot.

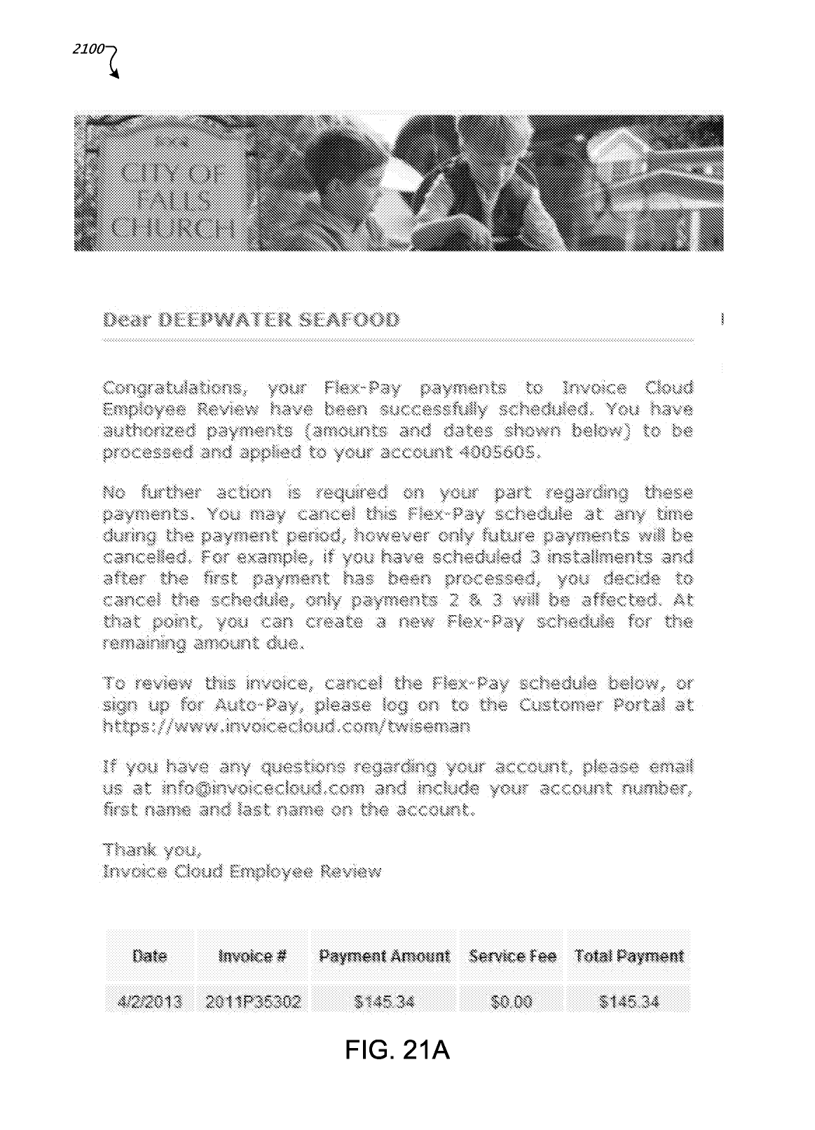

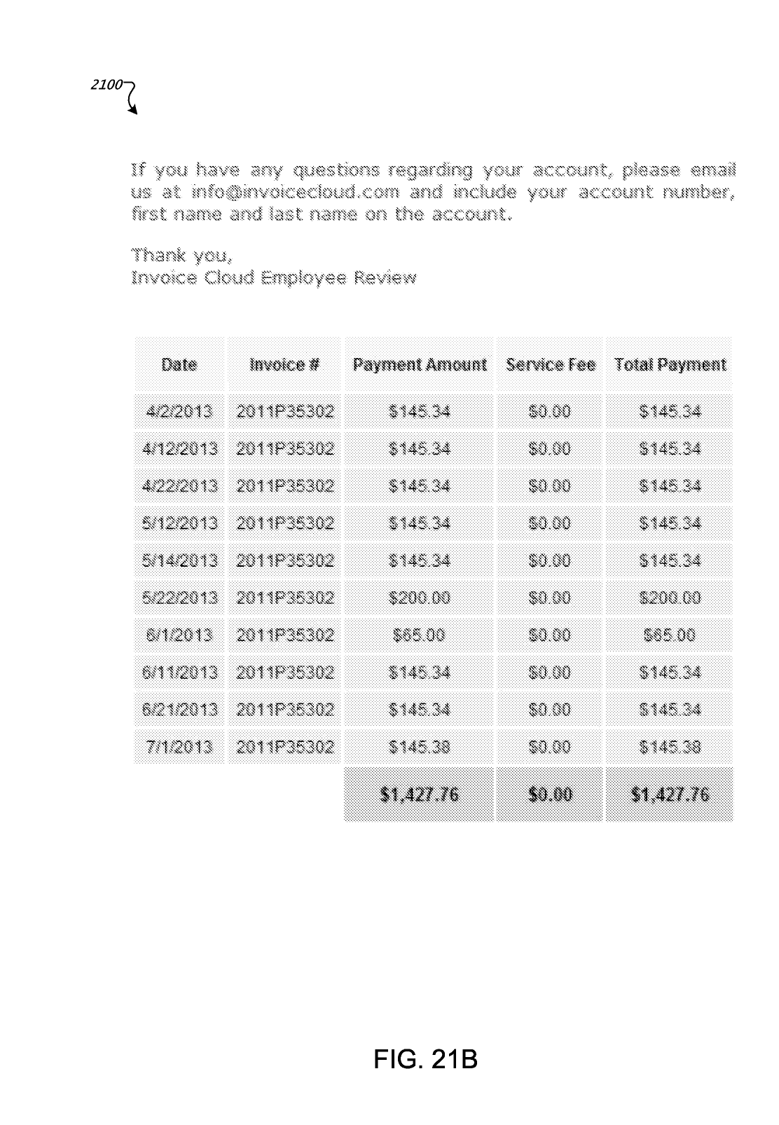

FIGS. 21A and 21B are screenshots.

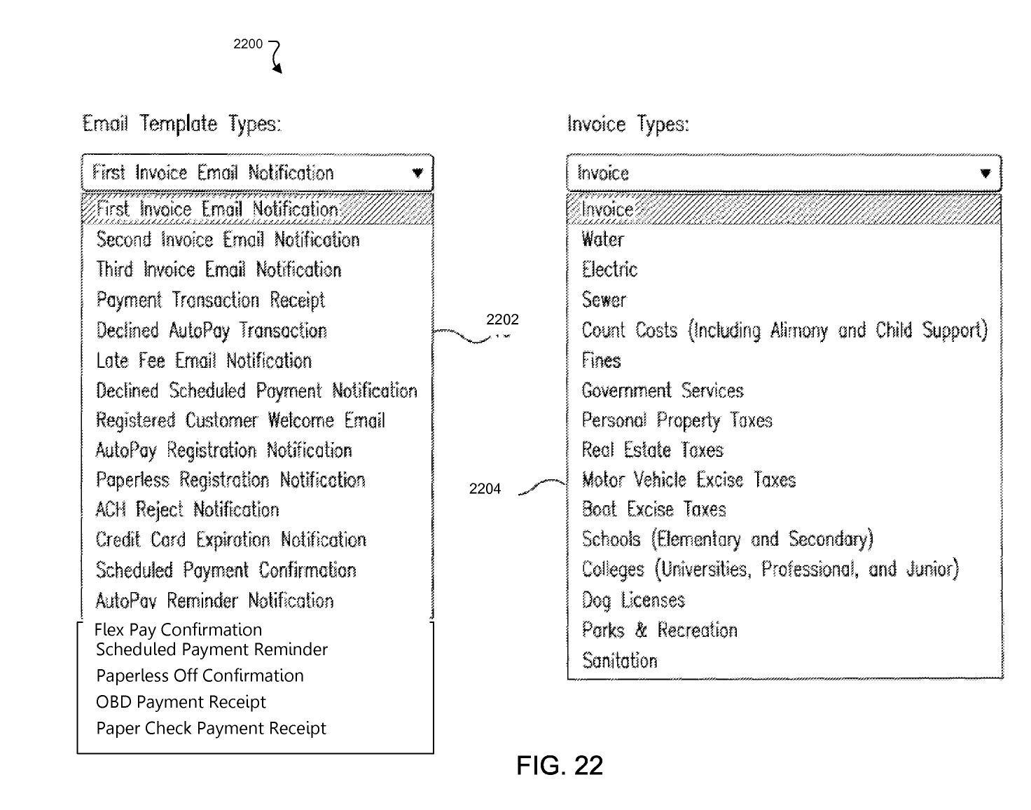

FIG. 22 is a screenshot.

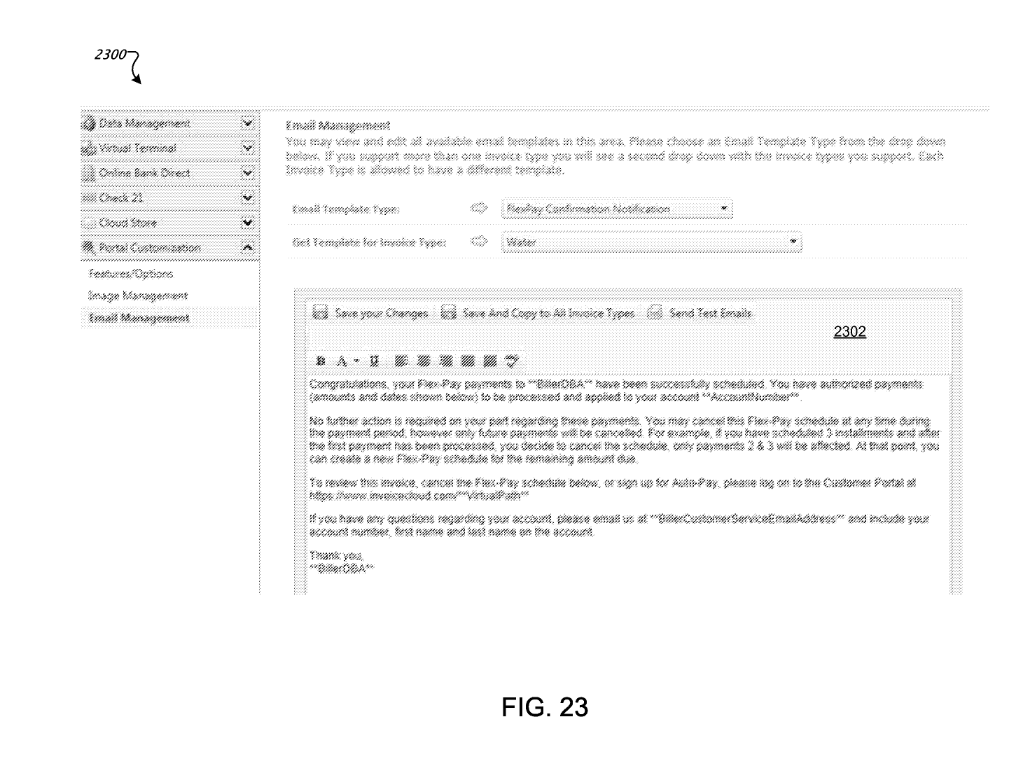

FIGS. 23-27 are email notifications.

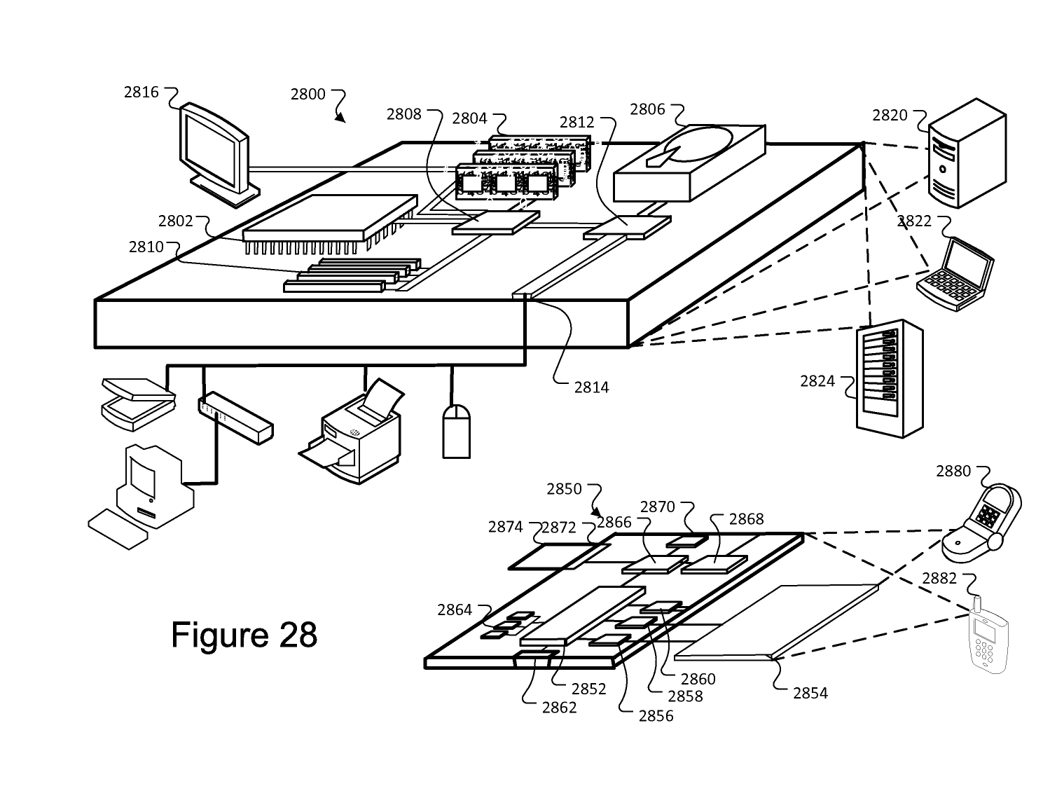

FIG. 28 is a block diagram.

We describe here an electronic invoice and payment system that provides billing services on behalf of multiple, independent billers. Each biller can design its own branded customer portal (accessible for example, through the Web or through a mobile device) that is hosted by the system and is visible to the biller's customers. Through the customer portal, customers can view invoices, view payment history, make service requests, schedule payments, or a combination of any two or more of them.

Each biller can independently specify business rules related to the payment of its invoices by its customers. For instance, a biller can design its portal to allow flexible payment schedules so that a customer can pay his invoice according to a schedule specified by the customer himself.

Each biller can independently generate notifications to be sent to its customers or can edit preset templates for the notifications provided by the electronic invoice and payment system. Each biller can specify business rules governing when each type of notification is to be sent. For example, a utility biller can elect to have two or three electronic mailed invoice notifications sent to customers who have a balance above $0.00 and can elect to send electronic mailed shut off notices to customers who are past due.

The electronic invoice and payment system can process payments of customers on behalf of each biller. A customer can make a payment directly to the electronic invoice and payment system, e.g., using a credit card or debit card or a direct withdrawal from a bank account. A customer can make a payment directly to a biller, for instance, by writing a check or by using an online bill service provided by an online bank. The electronic invoice and payment system can analyze each payment received by a biller to determine which invoice, if any, the payment corresponds to. The electronic invoice and payment system can determine a correspondence between a payment and an invoice based on previously identified matches between payments and invoices.

Referring to FIG. 1, an electronic invoice and payment system 100 provides billing services on behalf of billers 102a, 102b and provides payment services to customers 104a, 104b, 104c of the billers. By a biller, we mean broadly, for example, any entity that issues bills to its customers. For instance, a biller can be a utility company that issues electric bills and gas bills. A biller can be a city or town that issues several types of bills, such as water and sewer bills, real estate tax bills, and motor vehicle excise tax bills. A biller can be a property management company that issues rent bills and utility bills. By a bill we mean broadly, for example, any representation that is presented to a party in any form and refers to an amount due. By customers, we mean the people or entities that receive the bills, pay the bills, or both. For instance, customers of a city can include residents of the city, landlords who own property in the city, and businesses operating in the city. Customers of a property management company can include tenants in buildings operated by the property management company.

A centralized server 106 (or multiple centralized servers) enables the electronic invoice and payment system 100 to provide individualized billing services to multiple independent, unrelated billers. For instance, the biller 102a and the biller 102b can be two independent, unrelated entities, such as the city of Cambridge, Mass., and the Tucson Municipal Light Department. Portals for a very large number of unrelated billers can be hosted by the electronic invoice and payment system. Invoice data 108 and payment data 110 for each biller 102a, 102b are maintained in an invoice database 112 hosted by the centralized server 106. Invoice data 108 for a particular biller can include, for each customer of the biller, an amount due, a due date, an invoice number, and an account number for each type of invoice (we sometimes use the word invoice interchangeably with bill) issued by the biller. A particular biller may issue more than one type of bill. For example, a city may issue various types of tax bills, water and sewer bills, bills for civil fines, bills for dog licenses, and other types of bills.

Payment data 110 for a particular biller can include records of payments toward each invoice of each customer, including, for each payment, the amount and date of the payment and the account number or invoice number to which the payment was applied. The total of the payments included in the payment data 110 is credited to the biller's account. The invoice data 108 and payment data 110 maintained in the invoice database 112 can be encrypted for security. For instance, each item of data maintained in the invoice database 112 can be separately encrypted so that any unauthorized attempt to overcome the encryption can only succeed in obtaining a single item of data.

The electronic invoice and payment system 100 provides a biller portal 114, typically separate from the customer portal, through which each biller can control the experience of its own customers. By experience, we mean broadly, for example, the simplicity or complexity, richness of features, speed, accuracy, privacy, and other features of the portal that contribute to the look and feel of the portal and the process of using it. Each biller 102a, 102b accesses the biller portal 114 through a network connection, such as the Internet, between a respective computing device 103a, 103b and the centralized server 106 of the electronic invoice and payment system 100. Through the biller portal 114, each biller can create a customized, branded customer portal 116 that can be accessed by its customers. Each biller can also use the biller portal 114 to set business rules related to customer payments, customer communications, payment processing, or other features, or a combination of any two or more of them.

Referring also to FIG. 2, the branded customer portal 116 can be customized by the biller to include features such as, e.g., the name of the biller (Hingham, Mass., in this example), a logo or motto of the biller, an address or phone number of the biller, colors associated with the biller (e.g., town colors), other features specific to the biller, or a combination of any two or more of these features. Customers 102a, 102b can access the branded customer portal 116 through a network connection, such as the Internet, between a respective computing device 105a, 105b and the centralized server 106 of the electronic invoice and payment system 100. Since the branded customer portal 116 appears to the customer as if it were generated and hosted by the biller and because it has been designed by the biller specifically to serve its customers in the context of the transactional relationship between the biller and its customers, the customers may be comfortable interacting with the customer portal 116, e.g., to view or pay invoices, to enroll in paperless billing, or to provide payment or contact information.

Referring to FIG. 3, an image management screen 300 of the biller portal 114 enables a biller to specify one or more images to be displayed on the branded customer portal 116. For instance, the biller can specify one or more images to be displayed as a header or footer of the customer portal 116, as a logo on an invoice viewed through the customer portal 116, as a header of an email notification, or as a header of an express pay screen of the customer portal 116.

Each biller can use the biller portal 114 to specify business rules to be applied to one or more types of invoices issued by the biller. By business rules, we mean broadly, for example, any principles, guidelines, procedures, or other aspects of how an entity conducts or intends to conduct its operations internally and its relationships with other parties. Business rules can include, e.g., whether partial payments or overpayments are allowed, whether a payment for an invoice can be split among multiple payment methods, when a late fee is to be charged, or other business rules. In some examples, a biller can specify a business rule that applies to all invoices issued the biller. For instance, a biller may specify that a late fee of $5.00 is to be charged on every invoice that is paid more than five days after its due date. For instance, a biller may not allow any payment for any type of invoice to be split among multiple payment methods. In some examples, a biller can specify a business rule that applies to only one or more particular types of invoices issued by the biller. For instance, a biller may specify that partial payments are allowed for utility bills but that tax bills must be paid in full. For instance, a biller may specify that customers can enroll in paperless billing for water and sewer bills but must receive paper invoices for real estate tax bills. For instance, a biller can set a separate convenience fee for online payment and a separate prompt payment discount for each type of invoice issued by the biller.

Each biller can use the biller portal 114 to customize the presentation of invoices to its customers. For instance, if a biller issues multiple invoices of one type or multiple types of invoices or both to each customer, the biller can aggregate some or all of these multiple invoices into a single overall invoice. A single invoice can be easier for a customer to pay than multiple disparate invoices, and thus the ability to present a single invoice can help to increase collections yield for the biller. For instance, a biller who is a landlord may generate a single monthly invoice including a rent bill and bills for utilities, such as water, electric, and gas, that are initially billed to the landlord from the utility company.

For instance, referring to FIGS. 4A and 4B, a payment screen 400 of the biller portal 114 enables a biller to allow customers to pay one or more types of invoices with automatic payments 402. The biller can select the types of invoices 404 for which automatic payments are permitted. The payment screen also enables a biller to allow customers to schedule payments 406. The biller can select the types of invoices 408 for which payments can be scheduled. For instance, referring to FIG. 5, a service fee screen 500 of the biller portal 114 enables a biller to specify service fee options for credit card payments 502, electronic check payments 504, or both. For instance, referring to FIG. 6, a miscellaneous business rules screen 600 of the biller portal 114 enables a biller to allow customers to update address and phone information 602, to allow customers to indicate that they want to continue receiving paper invoices 604 for one or more types of invoices 606, to provide information 608 about a refund policy, and to specify a customer service phone number 610. Other business rules can also be specified via other screens of the biller portal 114.

In general, features that can be customized can include one or more of the following:

Features that can be customized by invoice type:
Paperless options: allow paperless billing; allow customers to request paper billing.
Payment scheduling: allow scheduled payments; allow automatic payments.
Registration: allow customer registration through a customer portal; display one or more registration questions; specify one or more registration questions.
Email notifications: override paperless confirmation notifications; override automatic payment confirmation notifications.
Email addresses: require email address re-entry for registration; require email address re-entry for payment methods where email address can be edited.
Invoice balances: balance forward for invoices that have the same biller bill year as a current invoice; allow customers to submit payment greater than invoice balance due; allow customers to submit payment on zero balance invoices; allow customers to submit payment on negative balance invoices; allow scheduled payments to process on zero balance invoices; allow scheduled payments to process on negative balance invoices; specify invoice balance to trigger a second or third email notification to be sent to a customer.
Payment methods: block payments from one or more types of credit cards.

Biller options that can be customized:
Allow adjustments on closed invoices. A biller can enable this option to allow a payment, adjustment, or both to be applied to a closed invoice. A biller may disable this option, for instance, in the case of balance forward accounting, in which the balance of a previous invoice is adjusted out and moved to a new invoice and no further payments or adjustments are allowed to the previous invoice.
Paperless checkbox default. When registering or when making a payment as an unregistered user, a customer is presented with a checkbox allowing the customer to enroll in paperless billing. A biller can choose to have the checkbox checked or not checked as the default.
Allow credit card as default payment method. Customers can have the option to pay with credit card, debit card, or direct from a bank account. A biller can choose to set one of these payment methods as the default payment method.
Only send invoice notifications to registered customers. By default, invoice notifications can be emailed to all customers of a biller. A biller can select this option to have notifications emailed only to customers who are active and registered with the electronic invoice and payment system.
Display invoice number in customer portal. By default, the invoice number can be visible to a customer viewing certain areas of the customer portal, such as an invoice or a scheduled payment screen. A biller can select this option to hide the invoice number from the customer.
Display account number in customer portal. By default, the account number can be visible to a customer viewing certain areas of the customer portal. A biller can select this option to hide the account number from the customer.
Batch detail. Reporting of open and settled batch detail in the biller portal can be set to display invoice numbers, account numbers, or both
Allow automated clearing house (ACH) payment reject reversals. A biller can enable or disable the option to reverse ACH rejects through the biller portal.
Automatic payments and paperless billing for multiple invoice billers. A biller that issues multiple types of invoices can enable a setting such that if a customer enrolls in paperless billing for one type of invoice, the customer will be enrolled in paperless billing for all types of invoices. Similarly, the biller can enable a setting such that if a customer sets up automatic payments for one type of invoice, automatic payments will be set up for all types of invoices for that customer.
Allow paperless registration. A biller can allow or prohibit enrollment in paperless billing while a customer is registering with the customer portal, while an unregistered customer is paying an invoice through the customer portal, or both.
Display paperless options. A biller can allow a paperless options menu item on the customer portal, a paperless tab in the biller portal, or both, to be displayed or hidden.
Allow customer to turn off automatic payments. A biller can allow or prohibit cancellation of automatic payments by a customer.
Customer portal log on. A biller can allow a customer to log on to the customer portal using an email address, an account number, or both. A biller can customize text describing the type of identification a customer uses to log on to the customer portal.
24 hour adjustments. By default, adjustments to an invoice can be prohibited if a payment was made to the invoice within the last 24 hours. A biller can override this prohibition.
Start over. While going through the process of making a payment for a selected item through the customer portal, a customer may be given an option to start over. A biller can select the destination of the starting over as either the same selected item or the customer portal landing page.
Payment discounts. A biller can create payment discounts, such as prompt payment discounts for offline payments, real time payments, or both. A biller can override specified discounts and can control the clearing of discounted amounts.
Customer portal registration display. A biller can select whether an icon is displayed on the customer portal indicating that a customer is already registered.
Automatic payments. A biller can specify whether an automatic payment is to pay the current balance due, the initial balance due, the lesser of the two, or the greater of the two.
Passwords. A biller can specify whether customer passwords, a customer password reset option, or both, are displayed in the customer portal.
Account number reentry. A biller can specify whether a customer must reenter a bank account number for each payment. A biller can specify whether a customer must reenter an account number, such as an account number with the biller, when adding a new payment method.
Express payments. A biller can specify whether a customer must enter an email address when making a payment as an unregistered user.
Payment routes. A “pay other” option may be available to a customer making a payment through the electronic invoice and payment system. A biller can specify whether each invoice line item in the pay other option displays the invoice number, the account number, or both.
Customer portal debit selection. If a biller allows payments on invoices with a credit balance, the biller can allow or prohibit selection of those invoices along with invoices with a balance due. The credit balance of one invoice can then be used to reduce the total balance due for all selected invoices.
Opt out of notifications. A biller can allow a customer to opt out of receiving invoice notifications or prohibit opting out.
Customer portal email updates. A biller can allow or prohibit updating of an email addresses through the customer portal.

Invoicing options that can be customized:
Partial payments can be allowed for one or more types of invoices.
Services fees can be defined for one or more types of invoices.
Late fee amounts, due dates, notification triggers, and other late fee options can be defined for one or more types of invoices.
Balance forward can be allowed for one or more types of invoices.

Other features can also be customized, for instance, as described in U.S. Patent Pub. No. 2011/0270749, the contents of which are incorporated here by reference in their entirety.

Referring to FIGS. 1 and 7, when a biller (e.g., the biller 102a) issues invoices (700), an invoice file 118 is uploaded from the computing device 103a to the electronic invoice and payment system 100 (702). The invoice file 118 is stored in the invoice database 112. For each invoice, the invoice file 118 can include information about, e.g., the type of invoice (e.g., an electric bill), the amount due on the invoice, the due date of the invoice, the customer of the invoice (e.g., a name, address, customer identifier, or a combination of any two or more of them), an invoice number, an account number, or other information about the invoice, or a combination of any two or more of them. For instance, the invoice file 118 can include, e.g., one or more of the following fields:

General file data
File identifier assigned by the biller
Date and time the invoice file was created.
Total number of invoices included in the invoice file.
Total dollar amount of invoices included in the invoice file.

Invoice data for each invoice
Invoice number.
Date the invoice was created.
Date the invoice is due.
Total amount billed on the invoice when it was created.
Total amount of tax due on the invoice.
Total discount on the invoice.
Total shipping due on the invoice.
Total duty due on the invoice.
The value added tax (VAT) rate due on the invoice.
The VAT amount due on the invoice.
Whether partial payments are allowed (i.e., whether a customer is allowed to pay less than the full amount due on the invoice).
Minimum amount due. If partial payments are not allowed, the minimum amount due equals the total amount due.
Terms. A free text field that can be filled in by the biller to let the customer know the terms of the invoice.
First date an email notification of the invoice was sent (or is to be sent) to the customer.
Second date an email notification of the invoice was sent (or is to be sent) to the customer.
Third date an email notification of the invoice was sent (or is to be sent) to the customer.
Purchase order number associated with the invoice.
Sales representative associated with the invoice.
Date the invoiced product shipped.
Tracking number of the shipping company delivering the invoiced product.
Identifier of the shipping company.
Name of the person to whom the invoiced product was shipped.
Address to where the invoiced product was shipped.
Phone number of the location to where the invoiced product was shipped.
The balance due when the invoice is uploaded to the electronic invoice and payment system.
Late fee amount to add to an existing balance on the late fee date.
Late fee date when the balance due is to be adjusted to include the late fee amount.
Instructions whether or not to add a detail record to the invoice when the late fee is added to the balance due.
Late fee description to be used for the new line item that is added when the balance due is adjusted to include the late fee amount.
Instructions whether to send an email notification if the invoice has not been paid by the late fee date.
Instructions whether to apply the late fee if the invoice has no payments or to apply the late fee if the customer has made a partial payment to the invoice.
Credit card service fee charged in addition to standard credit card payment.
Automated clearing house (ACH) service fee charged in addition to standard ACH or electronic funds transfer (EFT) payment.
Instructions whether to close out all previous invoices with credit adjustments for the customer (balance forward).
The automatic payment collection date.
The dollar amount of the discount the customer will receive if the invoice is paid before the prompt payment date.
The prompt payment date.
Text to be used on the invoice as a description for the prompt payment discount.
The payment expiration date (i.e., the last date that the customer is allowed to pay the invoice through the electronic invoice and payment system).
A token that matches the invoices with the invoice record in the biller's invoice file.
The name of the file (e.g., a pdf file) that corresponds to a record in the invoice file.
A globally unique identifier that is used for multiple invoicing or sub-invoicing.
An installment number of the invoice.
A biller year of the invoice.
A biller bill number used to locate invoices for offline payment and adjustments.
The payment expiration message that is to be displayed to a customer trying to pay the invoice after the payment expiration date.
Fields are available for data elements that are returned with some payment related web services.
Fields are available for custom invoice header data.
Fields are available to provide aging information on the invoice.

Customer data for each invoice.
The account number of the customer.
The name of the customer.
The address of the customer.
The phone number of the customer.
The email address of the customer.
The VAT number of the customer.
A value that verifies the customer during registration (e.g., the last four digits of the customer's social security number). The value corresponds to the biller's registration question in the biller profile.
Instructions to allow or block credit card payments for the customer.
Instructions to allow or block EFT payments for the customer.
Second name for the customer.
Personal PIN number used as login credentials for the customer.

Invoice details for each invoice.
An identifier for the invoiced product or service.
A description of the invoiced product or service.
A quantity of the invoiced product or service.
A price per unit of the invoiced product or service.
A extended unit price of the invoiced product or service.
A discount.
An extended unit discount.
A unit tax amount.
A unit tax rate.
A total amount due for each line item.
Fields are available for custom invoice details.

Customers who are enrolled in paperless billing through the electronic invoice and payment system 100 (e.g., customers 102a, 102b) receive an email 120 from the electronic invoice and payment system 100 alerting them that an invoice has been issued by the biller 102a (704). These customers 102a, 102b can select a link in the email 120 to view the invoice in the customer portal 116. Customers not enrolled in paperless billing (e.g., customer 102c) receive a paper invoice 119 mailed to them from or on behalf of the biller 102a (706) and may also receive email alerts. The paper invoice can include instructions for how to view the invoice on the electronic invoice and payment system 100, how to enroll in paperless billing, or both.

A customer can view the invoice (708), pay the invoice (710), or both through the customer portal 116. In some examples, only customers who are registered with the electronic invoice and payment system 100 can pay invoices through the customer portal 116. In some examples, customers can pay invoices through the customer portal 116 regardless of whether they have registered with the electronic invoice and payment system 100. Each customer may be presented with several payment options for paying the invoice, depending on the business rules established by the biller issuing the invoice. For instance, the customer may be able to pay the entire amount due on the invoice immediately, make a partial payment immediately, or schedule one or more future payments.

A variety of payment methods can be available to customers. Customers (e.g., a customer 104b) can pay to the biller 102a through an online bill pay service provided through a bank 122 (which we refer to here as “online bank direct payments”). Customers (e.g., customer 104c) can pay directly to the biller 102a using a paper check 124 or cash, e.g., by mail or in person at a payment window. Customers (e.g., a customer 104a) can also pay directly to the electronic invoice and payment system 100 through the customer interface 116, e.g., by providing credit card, debit card, or bank account information (e.g., for automated clearing house (ACH) payments).

The payment data 110 is synchronized between the electronic invoice and payment system 100 and the biller's computing device 103a. For instance, a payment file 130 reflecting payments made directly to the electronic invoice and payment system 100 can be provided to the biller's computing device 103a. A payment file 131 reflecting payments made directly to the biller 102a can be provided to the electronic invoice and payment system 100. Payment data 110 can be synchronized at specified intervals, e.g., in real time, every one minute, every ten minutes, every hour, twice a day, or at another interval. The biller can specify the frequency of synchronization through the biller dashboard 114.

Payment files 130, 131 can each include, e.g., one or more of the following fields:

General file data.
File identifier assigned by the biller.
Date and time the payment file was created.
Total number of payments included in the payment file.
Total dollar amount of the payments included in the payment file.

Payment data for each payment.
Invoice number.
Account number of the customer.
Total amount of the payment.
Date the payment was made.
Payment method (e.g., credit card, electronic funds transfer, credit adjustment, check, cash, debit adjustment, or another payment method).
Payment message provided with a manual or offline transaction.
Payment reference provided with a manual or offline transaction.
Invoice type.
An installment number of the payment.
A biller year of the payment.
A biller bill number used to locate invoices for offline payments and adjustments.
Instructions to match the payment to the oldest invoice or the newest invoice.

In some examples, the payment files 130, 131 can reflect an adjustment to be made to an invoice. In these examples, the payment files 130, 131 can include one or more of the following fields:

General file data.
File identifier assigned by the biller.
Date and time the payment file was created.
Total number of adjustments included in the payment file.
Total dollar amount of the adjustments included in the payment file.

Adjustment data for each adjustment.
Invoice number.
Account number of the customer.
Total amount of the adjustment for the invoice.
Instructions to make a fixed amount adjustment or a balance differential adjustment.
Description for the adjustment entry.
Date the adjustment was made.
An installment number.
A biller year of the payment.
A biller bill number used to locate invoices for offline payments and adjustments.
Instructions to match the adjustment to the oldest invoice or the newest invoice.
Invoice type.

Frequent synchronization of payment records enables both the biller 102a and the electronic invoice and payment system 100 to maintain consistently updated payment data 110. For instance, the customer 102c can access the customer portal 116 to confirm that his account was credited with the paper check payment 124. Similarly, the biller 102a can see that an online payment has been made (e.g., directly to the electronic invoice and payment system 100 or through an online bank direct payment) immediately or soon after the payment is processed.

Referring to FIGS. 1 and 8, to enable online bank direct payments to a particular biller 102a, the electronic invoice and payment system 100 enrolls the biller 102a with one or more consumer service providers (CSPs) 132. CSPs 132 provide payment software 134 that banks expose to their customers for online bank direct payments. When a customer (e.g., customer 104b) authorizes an online bank direct payment 136 to the biller 102 through the bank 122 (800), the underlying CSP 132 routes the payment 136 from the customer's bank account to the biller 102a (802). The CSP 132 also sends a reporting file 138 to the electronic invoice and payment system 100 (804). The reporting file 138 includes payment information such as, e.g., the name of the customer 102b, the customer's address, the amount of the payment, a memo entered by the customer 102b, the date of the payment, other payment information, or a combination of any two or more of them. In some cases, the contents of the reporting file 138 can be specific to each CSP 132. The reporting file 138 does not generally include a remittance stub that associates the online bank direct payment to a specific invoice issued by the biller 102a. In other words, the electronic invoice and payment system receives information identifying the payments but then needs to take steps to determine which invoices relate to the payments.

When the reporting file 138 is received for a particular payment, the electronic invoice and payment system 100 applies a matching protocol to identify one or more invoices (including open invoices) to which the particular payment may apply (806). The matching protocol can consider a broad range of information in attempting to identify which invoice relates to each payment. For example, the payment information in the reporting file 138 and invoice information associated with invoices (including open invoices) of the biller. For instance, the matching protocol may search for invoices that have a customer name or address that matches the name or address in the reporting file 138, an amount due that matches the amount of the particular payment, an invoice number or account number that matches the contents of the memo line in the reporting file 138, or other types of matches. Invoices are assigned ratings based on the matching (808). For instance, the rating for a particular invoice can be based on the number of features that match between the particular payment and the particular invoice, the quality of each match, or both. In some examples, an incorrect match can be reversed. In some examples, payments can be accepted without matching to invoices, e.g., according to biller specified instructions.

Referring to FIGS. 8 and 9, the open invoices with the highest ratings can be presented to the biller for review on a matching screen 900 of the biller portal 114 (810). Invoice information 902, such as the name on the invoice, the account number or invoice number, the amount due, the issue date, the due date, or other invoice information, is displayed for each invoice. Payment information 904 for the particular payment is also displayed. For instance, in the example of FIG. 9, the highest ranked invoice 906 has an amount due that matches the amount of the payment and an invoice number that is similar to the contents of the memo line. The biller can manually confirm one of the displayed open invoices as matching the particular payment or can reject all of the displayed open invoices (812). If the biller confirms an open invoice as matching the particular payment, the payment is applied to that open invoice (814).

In some examples, all payments received through online bank direct are presented to the biller on the matching screen 900 for review. In some examples, some payments received through online bank direct are automatically matched with an open invoice and confirmed without input from the biller. For instance, if a particular payment matches a particular open invoice with a perfect rating, or with a rating above a predetermined threshold, the match can be confirmed without biller input.

Referring again to FIG. 1, this matching protocol can also be applied to payments received by the biller 102a by paper check 124. When a paper check is received by the biller 102a, the paper check 124 can be scanned or otherwise digitized. A check file 142 including scanned images of one or more paper checks can be uploaded to the electronic invoice and payment system 100. In the example of FIG. 1, the check file 142 is uploaded from the biller's computing device 103a. In some examples, paper checks can be scanned and uploaded by a third party, such as a check processing company.

The electronic invoice and payment system 100 processes the images in the check file 142 to identify payment information for each check such as, e.g., the name of the customer 102c, the customer's address, the amount of the payment, the contents of the memo line on the check 124, the date of the payment, other payment information, or a combination of any two or more of them.

The electronic invoice and payment system 100 applies the matching protocol to identify one or more open invoices to which each particular check may apply (806). The open invoices with the highest ratings can be presented to the biller for review on the matching screen 900. In some examples, the actual image of the particular check 124 is displayed as the payment information 904 on the matching screen 900. In some examples, the payment information 904 includes a rendering of a check or a list of the payment information from the check. The biller can manually confirm one of the displayed open invoices as matching the particular check or can reject all of the displayed open invoices. If the biller confirms an open invoice as matching the particular check, the check is applied to that open invoice.

Referring again to FIG. 1, the electronic invoice and payment system 100 can employ a learning protocol to improve the accuracy of the matching between payments (e.g., online bank direct payments, paper check payments, or both) and invoices. Records about each confirmed match between a payment and an open invoice is stored in a scrub file 144 or a database. The matching protocol can base matching between future payments and open invoices in part on the records about past matches stored in the scrub file 144. For instance, the scrub file 144 may include an entry recording a past match between a particular payer and a particular account number on an invoice. When another payment is received from that particular payer, open invoices with that particular account number may be assigned a higher rating.

Referring to FIG. 10, in one example of the learning protocol, an initial payment 1002 (e.g., an online bank direct payment or a paper check payment) is received and displayed in the matching screen 1000 of the biller interface 114. Two open invoices 1004a, 1004b are displayed as possible matches to the initial payment 1002. Both invoices 1004a, 1004b have a low rating 1006. The low rating may be due to the lack of a match between the name on the payment (Danforth Dental P.C.) and the names on the open invoices, the lack of a match between the amount of the payment and the amounts due on the open invoices, the lack of a match between the contents of the payment memo line and the account numbers or invoice numbers of the open invoices, or to the lack of other matching information, or to a combination of any two or more of them.

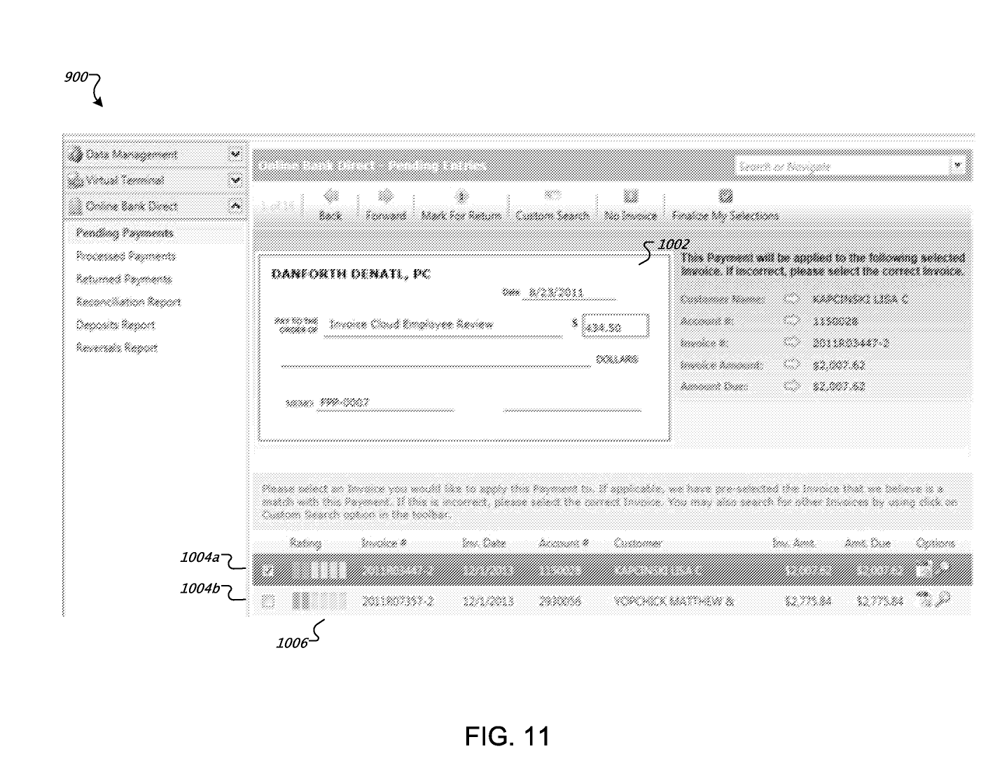

Referring to FIG. 11, the biller manually selects the invoice 1004a as the open invoice to which the initial payment 1002 is to be applied. For instance, the biller may be aware (e.g., through personal knowledge or research) that the name on the invoice 1004a (Lisa Kapcinski) is the girlfriend of the owner of Danforth Dental P.C. and that her bills are paid by Danforth Dental P.C. When the biller selects the invoice 1004a, an entry is made in the scrub file associating the payment information from the initial payment 1002 to the invoice information from the invoice 1004a. For instance, the entry can associate the names “Danforth Dental P.C.” and “Lisa Kapcinski” and can associate the memo contents “FPP-0007” with the account number “1150028.”

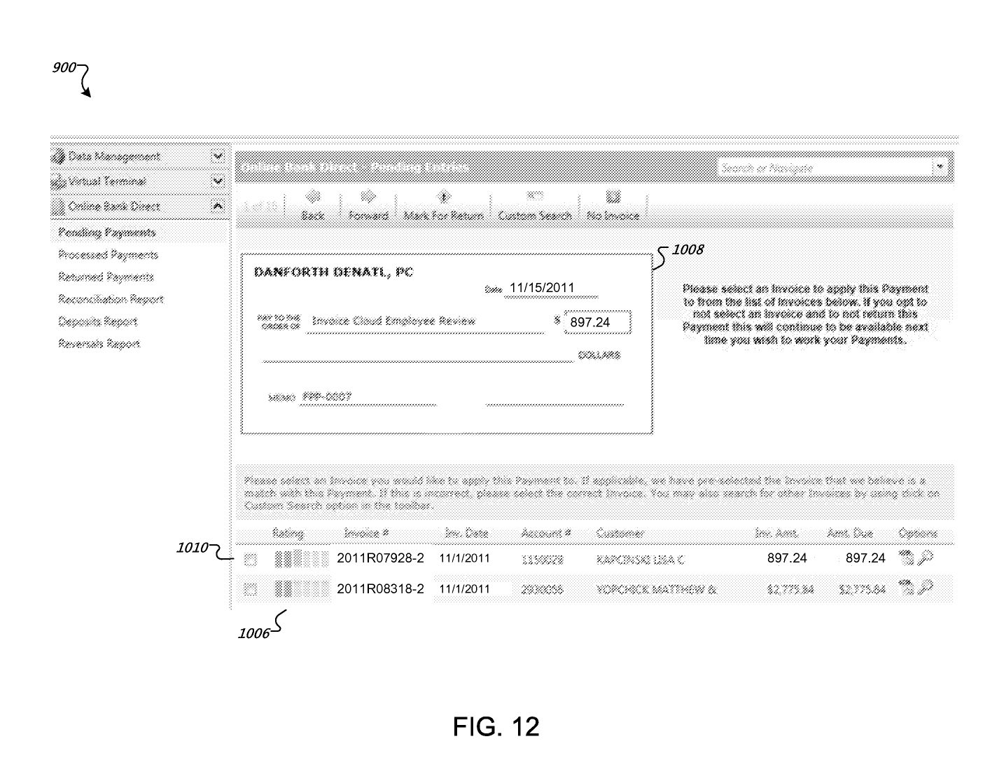

Referring to FIG. 12, when a subsequent payment 1008 (e.g., an online bank direct payment or a paper check payment) is received from Danforth Dental P.C., the matching protocol can refer to the scrub file in determining potential open invoice matches to the subsequent payment 1008. Because an entry in the scrub file associates the names “Danforth Dental P.C.” and “Lisa Kapcinski,” any invoices with the name “Lisa Kapcinski” can be given a higher rating. For instance, an invoice 1010 to Lisa Kapcinski is assigned a rating of three, which is one point higher than the initial rating of two that was assigned to the potential match between Danforth Dental P.C. and Lisa Kapcinski (FIG. 10).

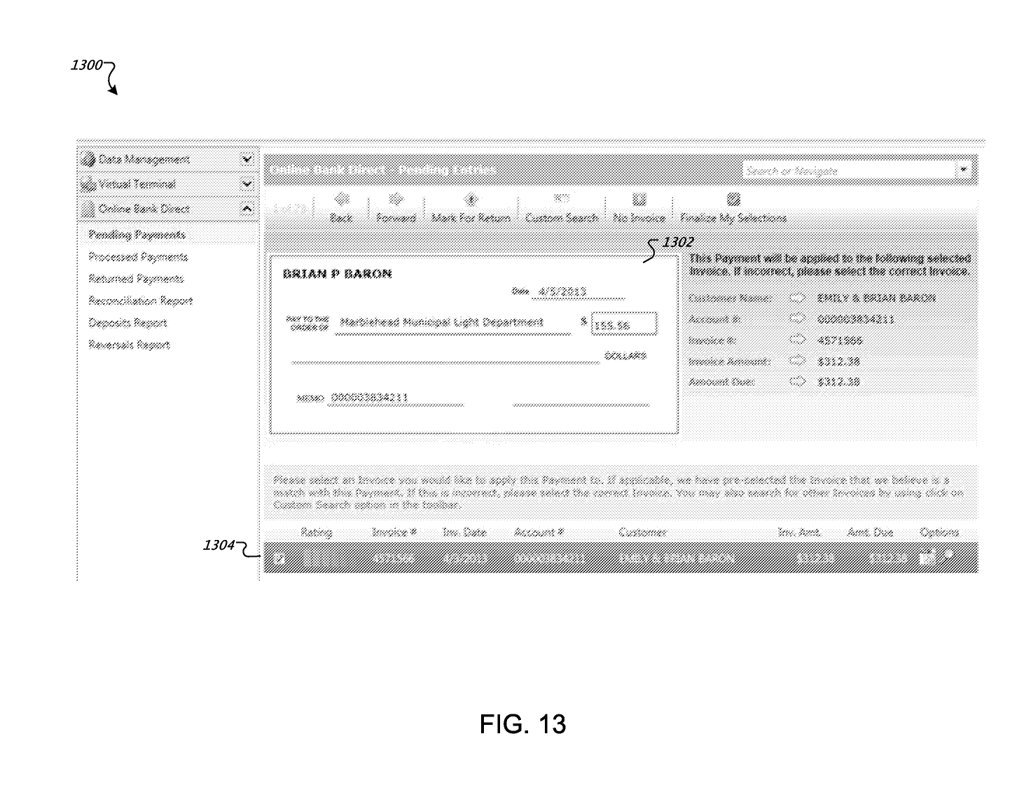

Referring to FIG. 13, in another example, a payment 1302 is received from Brian P Baron. Although no open invoices are identified with the exact name “Brian P Baron,” records in the scrub file indicate a long history of assigning payments with that name to invoices with the name “Emily & Brian Baron.” Based on this long history of matching, an invoice 1304 in the name of Emily & Brian Baron is assigned a perfect rating of six.

Referring to FIGS. 14A-14B, in one payment method, a customer (e.g., customer 102a shown in FIG. 1) can make a payment directly to the electronic invoice and payment system through a payment screen 1400 accessible from the customer portal. For instance, the customer can pay with a credit card, debit card, or by a direct withdrawal from the customer's bank account (e.g., by providing bank account and bank routing numbers to the electronic invoice and payment system). The customer can pay immediately or schedule one or more payments at future times.

The electronic invoice and payment system provides a self-service flexible payment interface (referred to here as a “flex pay interface”) that enables customers to set up a customized automated payment schedule (referred to here as a “flex pay schedule”). Customers can edit payment features such as the timing, amount, or mode of payment, or other payment features, or a combination of any two or more of them. That is, customers can customize a payment schedule to pay a particular invoice by specifying a number of payments, a frequency of payments, a date of each payment, an amount of each payment, or a combination of any two or more of them. Customers can create flex pay schedules for invoices that have already been issued, for invoices that have not yet issued, or both.

Referring to FIGS. 15 and 16, to establish a flex pay schedule for an invoice that has already issued, the customer selects the invoice (1500) from a list of open invoices on an account status screen 1600 of the customer portal.

Referring to FIGS. 15 and 17, selecting the invoice from the account status screen 1500 brings the customer to a payment screen 1700. The payment screen presents various payment options 1702, including payment according to a flex pay schedule 1704, an immediate one-time payment 1706, and a one-time payment scheduled for a future date 1708. To set up a flex pay schedule, the customer selects (1502) the flex pay schedule option 1704 from the payment screen.

The payment screen 1700 also allows the customer to select a payment method 1710 to be used for paying the invoice. In this example, the customer has linked only one payment method, a Visa® card, to his account with the electronic invoice and payment system. Other payment methods linked to a customer's account, such as other credit cards, debit cards, bank accounts, PayPal™ accounts, or other payment methods, can also be displayed. The customer selects (1504) the payment method to be used as a default payment method for the payments of the flex pay schedule.

Referring to FIGS. 15 and 18A-18C, a scheduling screen 1800 allows the customer to set up specific scheduling details of the flex pay schedule. For instance, the customer can specify a date 1802 for the first payment of the flex pay schedule (1506), a date 1804 for the last payment of the flex pay schedule (1508), and a number of payments (1510). In some examples, other payment features can be specified. For instance, the customer can specify a frequency of payments rather than a number of payments.

Referring to FIG. 19A, based on the scheduling details provided in the scheduling screen 1800, a flex payment schedule 1900 can be calculated. The flex payment schedule 1900 includes the dates and amounts of each payment. The calculation can be performed under the assumption that the payments are periodic (i.e., regularly spaced, to the extent possible) and that the total amount due on the invoice is to be evenly divided among all of the payments. For instance, in the example shown, a payment is to be processed every ten days and each payment is for the amount $145.34 (with the exception of the last payment of $145.38).

Referring to FIGS. 15 and 19B-19C, the customer can edit particular payments (1512) in the flex payment schedule 1900 to further customize the flex pay schedule. For instance, the customer can adjust one or more individual payment dates 1902 without affecting the other payment dates. The customer can adjust one or more individual payment amounts 1904. If the customer's adjustments of the payment amounts does not add up to the total amount due for the invoice, the system can automatically adjust the other payments, can generate a notification or an error, or can take no action.

In some examples, the customer can specify a payment method to be used for certain payments in the flex payment schedule 1900. By default, the payment method for the payments in the flex payment schedule 1900 is the payment method 1710 selected by the customer in the payment screen (FIG. 17). If the customer has multiple payment methods linked to his account with the electronic invoice and payment system, the customer can change the payment method for one or more payments in the flex payment schedule 1900. For instance, the customer may select a first credit card as the default payment method, but select a second credit card for every other payment to avoid overrunning his credit limit on the first credit card.

Referring to FIGS. 15 and 20, once the customer has finished customizing the flex pay schedule, a confirmation screen 2000 is displayed that summarizes the date and amount of each payment. The customer can cancel (1514) one or more particular payments from the confirmation screen 2000. In some examples, if the customer cancels a payment, a notification can be generated that warns the customer that the flex pay schedule is no longer sufficient to pay the total amount due for the invoice.

Referring to FIGS. 21A and 21B, in some examples, an email confirmation 2100 can be sent to the customer when a flex pay schedule has been established. The email confirmation can include the flex pay schedule, instructions for how to edit or cancel the flex pay schedule, instructions for how to access the customer portal of the electronic invoice and payment system, or other information. The email confirmation 2100 can be branded by the biller. The history of the emailed schedule can be stored for biller's review and future reference in the biller portal.

In some examples, a biller can establish business rules applicable to flex payment schedules. For instance, a biller can limit the number of payments in a flex payment schedule to no more than a maximum threshold number, such as no more than three payments, no more than five payments, no more than ten payments, or another maximum threshold. A biller can limit the amount of each payment to no less than a minimum threshold amount, such as no less than $1, no less than $5, no less than $20, or another minimum threshold. A biller can require that the sum of the individual payment amounts for a flex pay schedule equal the total amount due for the invoice being paid by that flex pay schedule.

The business rules can apply to all invoices issued by a biller or to only certain types of invoices issued by the biller. For instance, a biller may have a different minimum payment for each type of invoice. If a biller does not accept partial payments for a certain type of invoice, then flex pay scheduling is not allowed for that type of invoice. For instance, if partial payments are not accepted for motor vehicle excise tax bills, then flex payment schedules cannot be created for motor vehicle excise tax bills.

In the example depicted above, a flex payment schedule was established for an existing invoice that had been issued by a biller (i.e., a personal property tax invoice dated Jun. 1, 2013). In some examples, a flex payment schedule can be established for a particular type of invoice, even if no invoice of that type is currently open, as long as a preliminary invoice is created. For instance, a biller can upload preliminary bills, based on estimates from prior year history, for next year's real estate taxes and customers can schedule flex payments against those estimated bills.

The electronic invoice and payment system can automatically send email notifications to customers of a biller on behalf of the biller. The email notifications can be branded so that the emails appear to have been sent directly by the biller. Email notifications can be triggered by a variety of events, including a customer enrolling in paperless billing, a customer making or scheduling a payment, a biller issuing an invoice, and other events.

Basic, pre-populated templates can be provided for one or more types of email notifications. Each template can include standard content that is relevant to the event that triggers the corresponding email notification. For instance, a template for an email notification welcoming a newly registered customer can include a welcome message and basic instructions for using the electronic invoice and payment system. Each biller can edit the content, format, or both, of the templates, e.g., to add branding, to change the wording of text in the template, to include a locally relevant message (e.g., a message about a temporary parking restriction), or other actions.

Referring to FIG. 22, an email management interface 2200 can be accessed through the biller portal of the electronic invoice and payment system. The email management interface 2200 provides a template menu 2202 (e.g., a drop down menu) listing types of templates that are available to the biller for editing. The email management interface 2200 also provides an invoice menu 2204 (e.g., a drop down menu) listing types of invoices that can be issued by the biller. Example template types and invoice types are shown in the template menu 2202 and invoice menu 2204, respectively; other template types can also be available.

In some examples, the template menu 2202 and the invoice menu 2204 are specific to each biller (i.e., the template menu 2202 and the invoice menus 2204 displayed to a particular biller can list only template types and invoice types, respectively, that are relevant to that particular biller). In some examples, the template menu 2202 and the invoice menu 2204 list all template types and invoice types supported by the electronic invoice and payment system.

To customize a pre-set template, the biller selects the template type from the template menu 2202. The template can be customized globally for all invoice types for a particular biller or can be customized specifically for a particular one or more invoice types. If the biller wants to customize the selected template for particular invoice types, the biller also selects the relevant invoice types from the invoice menu 2204. The pre-set template of the selected type is displayed in an editing window, such as a text editor or a word processor, so that the biller can edit the content of the template, the formatting of the template, or both.

In some examples, a municipality can edit a registered customer welcome email to include a reminder about new parking rules, to include an image of the signature of the mayor, and to adjust the formatting of the template to match the formatting of the municipality's paper letterhead.

Referring to FIG. 23, an example email notification is a flex pay confirmation email 2300. In the example shown, the flex pay confirmation email is shown for a water bill. The flex pay confirmation email 2300 is automatically sent to a customer when he establishes a flex pay schedule. The flex pay confirmation email 2300 notifies the customer that the flex pay schedule has been established and provides a list of the scheduled payments, including the date and amount for each payment. An editing window 2302 allows the biller to edit the template for the flex pay confirmation email 2300.

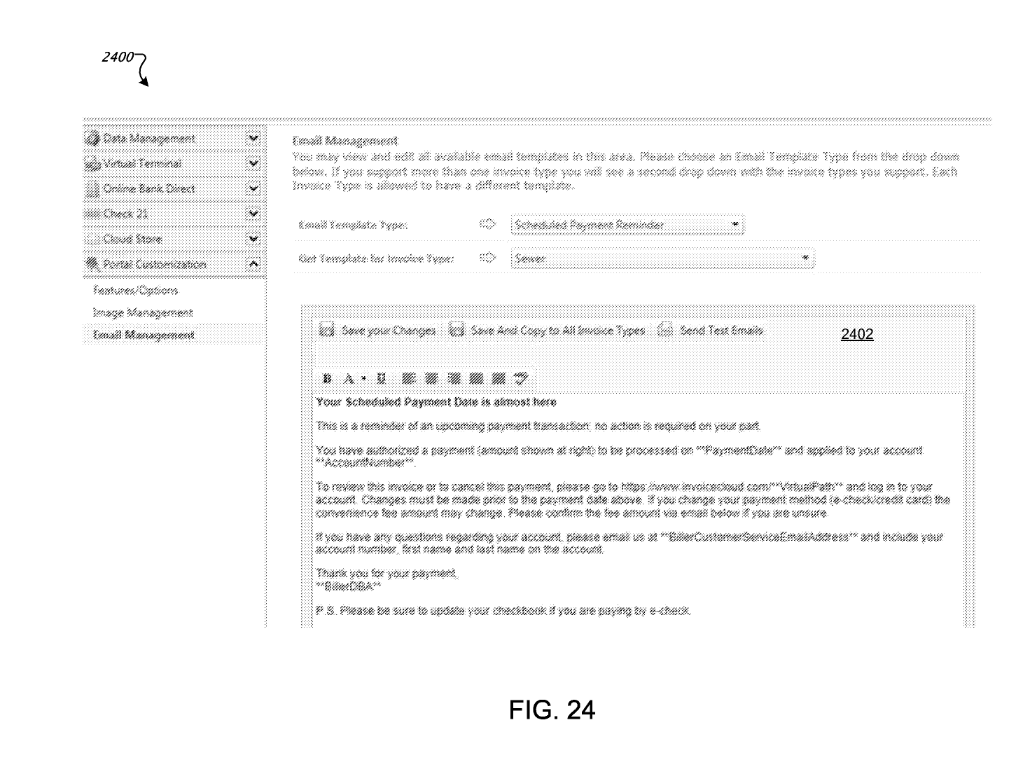

Referring to FIG. 24, an example email notification is a scheduled payment reminder 2400. In the example shown, the scheduled payment reminder 2400 is shown for a sewer bill. Scheduled payment reminders 2400 are sent to customers three days prior to their scheduled payment for their sewer bills. These reminders can help customers to ensure that there is enough money in their bank account, if the sewer bill is scheduled to be paid from a bank account. The reminders can also prompt users to change the payment method for the scheduled payment, cancel the scheduled payment, or make other changes to their scheduled payment. An editing window 2402 allows the biller to edit the template for the scheduled payment reminder 2400.

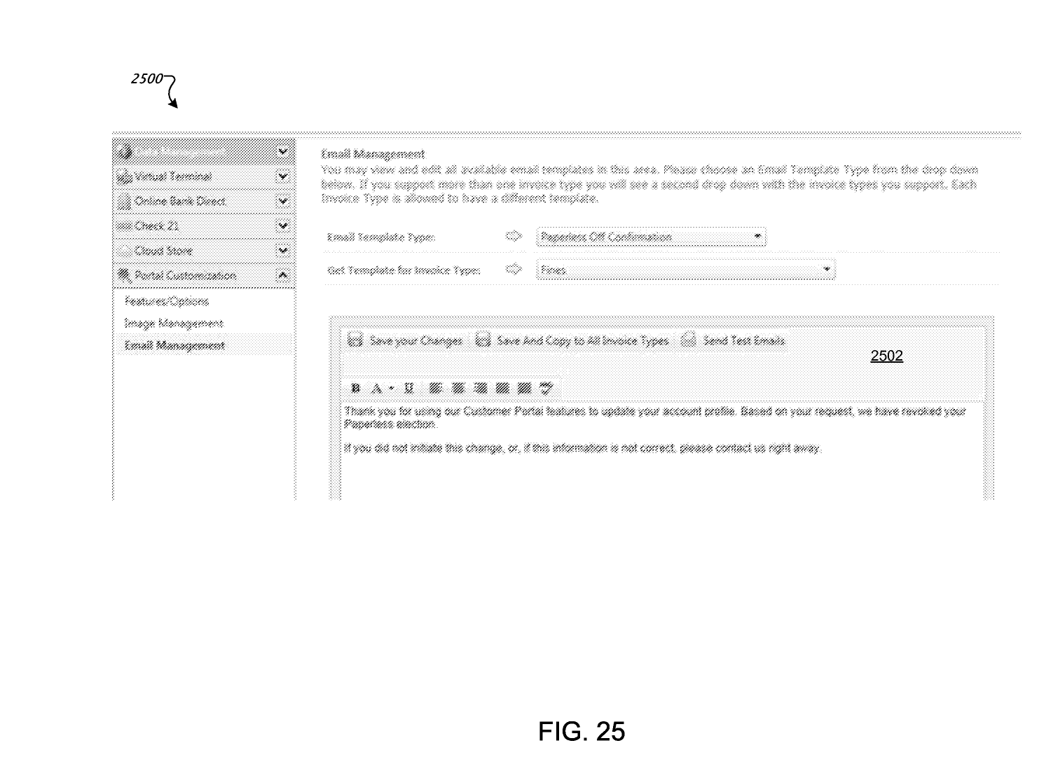

Referring to FIG. 25, an example email notification is a paperless off confirmation 2500. In the example shown, the paperless off confirmation 2500 is shown for invoices related to fines. Paperless off confirmations are sent to customers who cancel paperless billing (i.e., customers who opt to stop receiving invoices electronically and start receiving paper invoices in the mail). The paperless off confirmation can be stored in an email history for each customer, providing a helpful forensic for a biller wishing to track an email history for a customer. For instance, a biller who receives a complaint from a customer who claims to never have instructed the system to stop paperless billing can refer to the customer's email history to determine both that the customer did select to stop paperless billing and that the customer received a paperless off email confirmation. An editing window 2502 allows the biller to edit the template for the paperless off confirmation 2500.

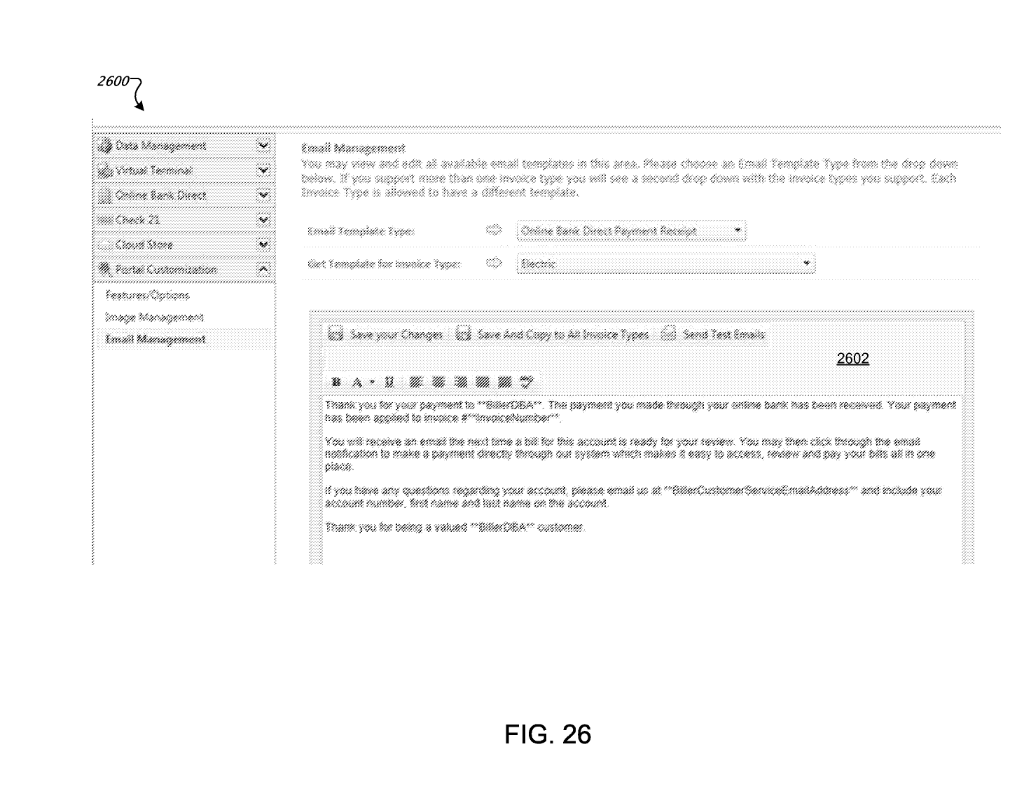

Referring to FIG. 26, an example email notification is an online bank direct (OBD) payment receipt 2600. In the example shown, the OBD payment receipt 2600 is shown for electric bills. OBD payment receipts 2600 can provide reassurance to customers paying their bills through OBD. For instance, a person who pays bills using a bill pay service provided by an online bank is not generally aware of when a payment has been received and processed by the biller. OBD payment receipts 2600 assure OBD customers that their payments have been received and processed. An editing window 2602 allows the biller to edit the template for the OBD payment receipt 2600.

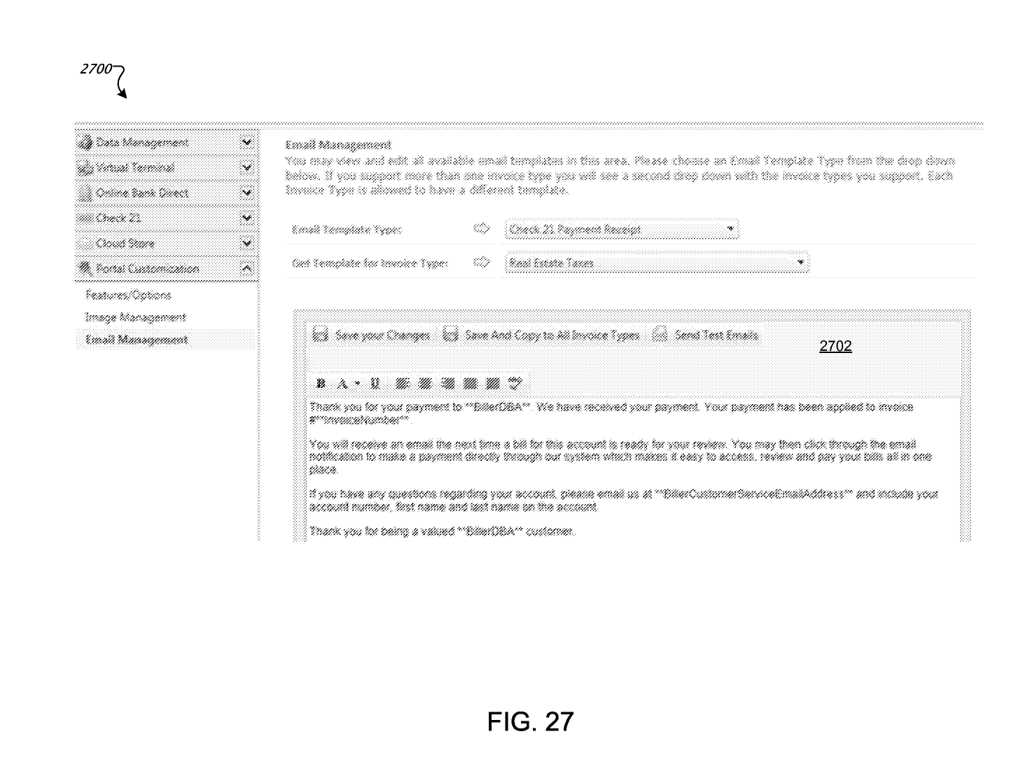

Referring to FIG. 27, an example email notification is a paper check payment receipt 2700. In the example shown, the paper check payment receipt 2700 is shown for real estate tax invoices. Paper check payment receipts can provide reassurance to customers paying their bills with paper checks to the biller. For instance, a person who pays bills using paper checks mailed or handed to the biller is not generally aware of when a check has been received and processed by the biller. Paper check payment receipts 2700 assure customers paying with paper checks that their payments have been received and processed. An editing window 2702 allows the biller to edit the template for the paper check payment receipt 2700.

Templates for other email notifications can also be provided, such as the template types listed in the template menu 2202.

In some examples, business rules can be associated with certain types of email notifications. For instance, second and third invoice email notifications can be sent to customers reminding them of upcoming invoice deadlines. A business rule associated with the second and third invoice email notifications can specify that the notifications are to be sent only to customers who have not already paid the invoice. This business rule can improve customer satisfaction, because customers will not receive emails that are not relevant for them (i.e., a customer who has already paid her bill does not need a second and third reminder about the bill). In some examples, business rules are associated with certain types of email notifications by default. In some examples, a biller can edit existing business rules, specify new business rules, or both, for its own email notifications.

In some examples, email notifications can be sent from a do-not-reply address. In some cases, the email notifications can include alias email headers to allow automatic redirection of a customer's reply to the biller.

In some examples, the electronic invoice and payment system can monitor the status of customers of a biller. If certain triggering events occur with respect to a particular customer, the electronic invoice and payment system can de-activate the customer from one or more services provided by the electronic invoice and payment system.

For instance, if an email sent to a customer is returned as undeliverable, the electronic invoice and payment system can automatically withdraw the customer from paperless billing so that the customer begins to receive paper invoices in the mail. This automatic withdrawal can help to ensure that customers receive invoices promptly and reliably.

The electronic invoice and payment system can also detect the conveyance of property (e.g., the selling of a home) by monitoring of public records, by input from a biller or another party, or by another method. When the electronic invoice and payment system detects, for instance, that a particular customer has sold his house, any automatic payments associated with that customer can be automatically suspended. Similarly, if the electronic invoice and payment system detects a name change of any kind on an invoice for a particular property (e.g., an address or a map/parcel in a town), the electronic invoice and payment system can automatically deactivate the prior customer's account. These automatic suspensions and deactivations can help to prevent former homeowners from continuing to receive invoices for property that they no longer own.

In some examples, the prior customer can be assigned a new account number. The prior customer's invoice history, payment history, stored payment information, and other data can be moved to the new account number. For instance, customer information for one or more customers can be stored in a conveyance file. The conveyance file can include one or more of the following fields:

General file data.
File identifier assigned by the biller.
Date and time the conveyance file was created.
The number of customers in the file who are to be conveyed.

Conveyance data for each customer.
The account number currently being used for the customer.
The new account number to be assigned to the customer.
Instructions whether to block the customer from making payments with a credit card.
Instructions whether to block the customer from making payments using electronic funds transfer.
Instructions whether to leave the customer's account active or to deactivate the customer's account.

FIG. 28 shows an example of a personal computing device 2800 and a mobile device 2850, which may be used with the techniques described here. Computing device 2800 is intended to represent various forms of digital computers, such as laptops, desktops, workstations, personal digital assistants, servers, blade servers, mainframes, and other appropriate computers. Computing device 2850 is intended to represent various forms of mobile devices, such as personal digital assistants, cellular telephones, smartphones, and other similar computing devices. The components shown here, their connections and relationships, and their functions, are meant to be examples only, and are not meant to limit implementations of the techniques described and/or claimed in this document.

Computing device 2800 includes a processor 2802, memory 2804, a storage device 2806, a high-speed interface 2808 connecting to memory 2804 and high-speed expansion ports 2810, and a low speed interface 2812 connecting to low speed bus 2814 and storage device 2806. Each of the components 2802, 2804, 2806, 2808, 2810, and 2812, are interconnected using various busses, and may be mounted on a common motherboard or in other manners as appropriate. The processor 2802 can process instructions for execution within the computing device 2800, including instructions stored in the memory 2804 or on the storage device 2806 to display graphical information for a GUI on an external input/output device, such as display 2816 coupled to high speed interface 2808. In other implementations, multiple processors and/or multiple buses may be used, as appropriate, along with multiple memories and types of memory. Also, multiple computing devices 2800 may be connected, with each device providing portions of the necessary operations (e.g., as a server bank, a group of blade servers, or a multi-processor system).

The memory 2804 stores information within the computing device 2800. In one implementation, the memory 2804 is a volatile memory unit or units. In another implementation, the memory 2804 is a non-volatile memory unit or units. The memory 2804 may also be another form of computer-readable medium, such as a magnetic or optical disk.

The storage device 2806 is capable of providing mass storage for the computing device 2800. In one implementation, the storage device 2806 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 2804, the storage device 2806, memory on processor 2802, or a propagated signal.

The high speed controller 2808 manages bandwidth-intensive operations for the computing device 2800, while the low speed controller 2812 manages lower bandwidth-intensive operations. Such allocation of functions is an example only. In one implementation, the high-speed controller 2808 is coupled to memory 2804, display 2816 (e.g., through a graphics processor or accelerator), and to high-speed expansion ports 2810, which may accept various expansion cards (not shown). In the implementation, low-speed controller 2812 is coupled to storage device 2806 and low-speed expansion port 2814. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 2800 may be implemented in a number of different forms, as shown in the figure. For example, it may be implemented as a standard server 2820, or multiple times in a group of such servers. It may also be implemented as part of a rack server system 2824. In addition, it may be implemented in a personal computer such as a laptop computer 2822. Alternatively, components from computing device 2800 may be combined with other components in a mobile device (not shown), such as device 2850. Each of such devices may contain one or more of computing device 2800, 2850, and an entire system may be made up of multiple computing devices 2800, 2850 communicating with each other.

Computing device 2850 includes a processor 2852, memory 2864, an input/output device such as a display 2854, a communication interface 2866, and a transceiver 2868, among other components. The device 2850 may also be provided with a storage device, such as a microdrive or other device, to provide additional storage. Each of the components 2850, 2852, 2864, 2854, 2866, and 2868, are interconnected using various buses, and several of the components may be mounted on a common motherboard or in other manners as appropriate.

The processor 2852 can execute instructions within the computing device 2850, including instructions stored in the memory 2864. The processor may be implemented as a chipset of chips that include separate and multiple analog and digital processors. The processor may provide, for example, for coordination of the other components of the device 2850, such as control of user interfaces, applications run by device 2850, and wireless communication by device 2850.

Processor 2852 may communicate with a user through control interface 2858 and display interface 2856 coupled to a display 2854. The display 2854 may be, for example, a TFT LCD (Thin-Film-Transistor Liquid Crystal Display) or an OLED (Organic Light Emitting Diode) display, or other appropriate display technology. The display interface 2856 may comprise appropriate circuitry for driving the display 2854 to present graphical and other information to a user. The control interface 2858 may receive commands from a user and convert them for submission to the processor 2852. In addition, an external interface 2862 may be provided to communicate with processor 2852, so as to enable near area communication of device 2850 with other devices. External interface 2862 may provide, for example, for wired communication in some implementations, or for wireless communication in other implementations, and multiple interfaces may also be used.

The memory 2864 stores information within the computing device 2850. The memory 2864 can be implemented as one or more of a computer-readable medium or media, a volatile memory unit or units, or a non-volatile memory unit or units. Expansion memory 2874 may also be provided and connected to device 2850 through expansion interface 2872, which may include, for example, a SIMM (Single In Line Memory Module) card interface. Such expansion memory 2874 may provide extra storage space for device 2850, or may also store applications or other information for device 2850. Specifically, expansion memory 2874 may include instructions to carry out or supplement the processes described above, and may include secure information also. Thus, for example, expansion memory 2874 may be provide as a security module for device 2850, and may be programmed with instructions that permit secure use of device 2850. In addition, secure applications may be provided through the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 2864, expansion memory 2874, memory on processor 2852, or a propagated signal that may be received, for example, over transceiver 2868 or external interface 2862.

Device 2850 may communicate wirelessly through communication interface 2866, which may include digital signal processing circuitry where necessary. Communication interface 2866 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 2868. In addition, short-range communication may occur, such as using a Bluetooth, WiFi, or other such transceiver (not shown). In addition, GPS (Global Positioning System) receiver module 2870 may provide additional navigation- and location-related wireless data to device 2850, which may be used as appropriate by applications running on device 2850.

Device 2850 may also communicate audibly using audio codec 2860, which may receive spoken information from a user and convert it to usable digital information. Audio codec 2860 may likewise generate audible sound for a user, such as through a speaker, e.g., in a handset of device 2850. Such sound may include sound from voice telephone calls, may include recorded sound (e.g., voice messages, music files, and so forth) and may also include sound generated by applications operating on device 2850.

The computing device 2850 may be implemented in a number of different forms, as shown in the figure. For example, it may be implemented as a cellular telephone 2880. It may also be implemented as part of a smartphone 2882, personal digital assistant, tablet computer, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used here, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well. For example, feedback provided to the user can be any form of sensory feedback (e.g., visual feedback, auditory feedback, or tactile feedback). Input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

Other implementations are also within the scope of the following claims.

What is claimed is:

1. A method comprising:
maintaining match data indicative of a correspondence between a past payment and a past invoice of a biller, the correspondence having previously been inferred from data associated with the past payment and data associated with the past invoice; and
inferring a correspondence between a received payment and another invoice of the biller based on (i) data associated with the received payment and data associated with the other invoice and (ii) the match data for the biller.

2. The method of claim 1, in which maintaining match data comprises maintaining match data for each of a plurality of billers, the match data for each biller indicative of a correspondence between a past payment and an invoice of the biller.

3. The method of claim 2, in which the match data for each biller is indicative of a correspondence between a plurality of past payments and a respective plurality of invoices of the biller.

4. The method of claim 1, in which maintaining match data comprises maintaining match data indicative of a correspondence between a plurality of past payments and a respective plurality of invoices of the biller.

5. The method of claim 1, in which the data associated with the received payment include one or more of a name associated with the received payment, an amount of the received payment, and contents of a memo associated with the received payment.

6. The method of claim 5, in which the data associated with the other invoice include one or more of a name associated with the other invoice, an amount due on the other invoice, a total amount due on an account associated with the other invoice, an account number associated with the other invoice, and an invoice number associated with the other invoice.

7. The method of claim 1, in which inferring a correspondence between a received payment and another invoice includes inferring the correspondence based on data associated with the past payment that matches data associated with the received payment, data associated with the past invoice that matches data associated with the other invoice, or both.

8. The method of claim 7, in which the data associated with the received payment comprises a name and the data associated with the past invoice comprises a name.

9. The method of claim 7, in which the data associated with the received payment comprises a name and the data associated with the past invoice comprises an account number.

10. The method of claim 1, in which inferring a correspondence between a received payment and another invoice includes rating the other invoice.

11. The method of claim 10, in which the rating is indicative of a degree of correspondence between the received payment and the other invoice.

12. The method of claim 10, in which rating the other invoice includes:
assigning a first rating to the other invoice based on the data associated with the received payment and data associated with the other invoice; and
assigning a second rating to the other invoice based on the match data.

13. The method of claim 12, in which the second rating is higher than the first rating.

14. The method of claim 13, in which the second rating is higher than the first rating when data associated with the past payment matches data associated with the received payment, data associated with the past invoice matches data associated with the other invoice, or both.

15. The method of claim 12, in which the match data are indicative of a correspondence between a plurality of past payments and a respective plurality of past invoices, and in which the second rating is based on a number of past payments for which data associated with the past payment matches data associated with the received payment, a number of past invoices for which data associated with the past invoice matches data associated with the other invoice, or both.

16. The method of claim 1, comprising identifying two or more other invoices corresponding to the received payment.

17. The method of claim 16, comprising rating each other invoice.

18. The method of claim 1, comprising associating the received payment with the other invoice.

19. The method of claim 18, comprising enabling processing of the received payment.

20. The method of claim 18, comprising enabling a payment confirmation notification to be sent to a recipient of the other invoice.

21. The method of claim 1, comprising enabling presentation of the data associated with the received payment, data associated with the other invoice, or both to a user.

22. The method of claim 1, comprising receiving input from a user about the other invoice.

23. The method of claim 22, in which the input from the user about the other invoice includes a confirmation of the inferred correspondence between the received payment and the other invoice.

24. The method of claim 23, comprising associating the received payment with the other invoice based on the confirmation.

25. The method of claim 1, comprising maintaining match data indicative of a correspondence between the received payment and the other invoice.

26. The method of claim 1, in which the past payment comprises a payment made by a paper check.

27. The method of claim 1, in which the past payment comprises a payment made by an online bank payment process.

28. A computer readable storage medium storing instructions for causing a computing system to:
maintain match data indicative of a correspondence between a past payment and a past invoice of a biller, the correspondence having previously been inferred from data associated with the past payment and data associated with the past invoice; and
infer a correspondence between a received payment and another invoice of the biller based on (i) data associated with the received payment and data associated with the other invoice and (ii) the match data for the biller.

29. A method comprising:
enabling a customer, through a user interface of a computing device, to specify a schedule for payment of an invoice, including enabling the customer to specify payment timing information; and
facilitating automatic payment of the invoice according to the payment schedule specified by the customer.

30. The method of claim 29, comprising determining a date and amount for each payment in the schedule based on the specified payment timing information.

31. The method of claim 30, comprising determining a data and amount for each payment in the schedule based on payment amount information specified by the customer.

32. The method of claim 29, comprising providing a date and an amount for each payment represented by the schedule for display on the user interface.

33. The method of claim 29, comprising enabling the customer to change a date, an amount, or both, for one or more payments represented by the schedule.

34. The method of claim 33, comprising determining an adjusted date, an adjusted amount, or both, for each payment represented by the schedule based on the change.

35. The method of claim 29, comprising enabling the customer to cancel a payment represented by the schedule.

36. The method of claim 35, comprising determining an adjusted date, an adjusted amount, or both, for each remaining payment represented by the schedule based on the cancellation.

37. The method of claim 29, in which the payment timing information includes one or more of a date for a particular payment, a number of payments, and a frequency of payments.

38. The method of claim 37, in which the date for a particular payment includes a date for a first payment in the schedule, a date for a last payment in the schedule, or both.

39. The method of claim 29, in which enabling a customer to specify a schedule includes enabling the customer to specify payment amount information.

40. The method of claim 29, in which the payment amount information includes an amount to be paid in each payment, a total amount to be paid over all payments, or both.

41. The method of claim 29, in which enabling a customer to specify a schedule includes enabling the customer to specify a schedule subject to a rule established by an entity issuing the invoice.

42. The method of claim 41, in which the rule includes a maximum number of payments, a minimum amount of each payment, or both.

43. The method of claim 41, comprising enabling the entity issuing the invoice to specify the rule.

44. The method of claim 29, comprising enabling a first customer to specify a schedule for payment of a first invoice issued by a first entity and enabling a second customer to specify a schedule for payment of a second invoice issued by a second entity independent of the first entity

45. The method of claim 44, in which enabling two or more customers to each specify a schedule includes enabling each customer to specify a schedule subject to a rule established by the entity issuing the invoice for the customer.

46. The method of claim 44, comprising enabling the first entity to specify a rule for the schedule independently of the second entity.

47. The method of claim 29, comprising enabling a schedule notification including the date, the amount, or both, of each payment represented by the schedule to be sent to the customer.

48. The method of claim 29, comprising enabling a scheduled payment notification to be sent to the customer a predetermined amount of time prior to the date of each particular payment represented by the schedule.

49. The method of claim 48, in which the predetermined amount of time is three days prior to the date of each payment.

50. The method of claim 29, comprising enabling a payment confirmation notification to be sent to the customer after each payment in the schedule is completed.

51. A computer readable storage medium storing instructions for causing a computing system to:
enable a customer, through a user interface of a computing device, to specify a schedule for payment of an invoice, including enabling the customer to specify payment timing information; and
facilitate automatic payment of the invoice according to the payment schedule specified by the customer.

52. A method comprising:
enabling a customer to establish automatic payments through a payment system for one or more invoices related to a property; and
based on a change related to a person associated with the property,
canceling the automatic payments through the payment system for the one or more invoices related to the property.

53. The method of claim 52, in which the change in a person associated with the property includes a change in ownership of the property.

54. The method of claim 53, in which the change of ownership of the property includes that the customer does not own the property.

55. The method of claim 53, in which detecting a change in ownership includes detecting that the property has been bought, sold, or both.

56. The method of claim 53, in which the change in ownership includes a name on a title for the property.

57. The method of claim 56, in which the change in ownership includes a change in the name on the title for the property.

58. The method of claim 56, in which the change in ownership of the property includes a change in a public record associated with the property.

59. The method of claim 52, in which the customer is a first customer, and in which the change in a person associated with the property includes that a second customer performs an action associated with the property through the payment system.

60. The method of claim 52, in which customer is a first customer, and in which the change in a person associated with the property includes that a second customer establishes an account with the payment system, links an established account with the property, or both.

61. The method of claim 52, in which a change in a person associated with the property includes a change in a name associated with the one or more invoices.

62. The method of claim 61, in which a change in a name associated with the one or more invoices includes that the name of the customer is not associated with the one or more invoices.

63. The method of claim 52, comprising detecting the change in a person associated with the property.

64. The method of claim 63, in which detecting the change includes automatically detecting the change.

65. The method of claim 64, in which automatically detecting the change includes detecting the change without requesting input from a user.

66. The method of claim 52, in which canceling the automatic payments includes automatically canceling the automatic payments.

67. The method of claim 66, in which automatically canceling the automatic payments includes canceling the automatic payments without requesting input from the customer, from a user other than the customer, or both.

68. The method of claim 52, comprising requesting confirmation of the cancellation from the customer.

69. The method of claim 68, in which requesting confirmation includes requesting confirmation prior to canceling the automatic payments.

70. The method of claim 52, comprising sending a cancellation notification to the customer.
